(19) United States
(12) Patent Application Publication
(10) Pub. No.: US 2007/0264721 A1
(43) Pub. Date: Nov. 15, 2007

(54) SYSTEM AND METHOD FOR ANALYTE MEASUREMENT USING A NONLINEAR SAMPLE RESPONSE

(76) Inventor: Harvey B. Buck, Indianapolis, IN (US)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(21) Appl. No.: 11/746,465

(22) Filed: May 9, 2007

Related U.S. Application Data
(63) Continuation-in-part of application No. 10/688,312, filed on Oct. 17, 2003.

(51) Int. Cl. G01N 27/00; B01J 19/08

(52) U.S. Cl. 436/150; 422/82.01

(57) ABSTRACT

The systems and methods of the present invention utilize a linear component of a non-linear, faradaic current response generated by a biological fluid sample when an AC excitation potential sufficient to produce such a faradaic current response is applied to the sample, in order to calculate the concentration of a medically significant component in the biological fluid sample. The current response is created by the excitation of electrochemical processes within the sample by the applied potential. Typically, the linear component of the current response to an applied AC potential contains phase angle and/or admittance information that may be correlated to the concentration of the medically significant component. Also typically, the fundamental linear component of the current response is utilized in the disclosed systems and methods. Harmonics of the fundamental linear component may also be used. Other methods and devices are disclosed.

### CROSS-REFERENCE TO RELATED APPLICATIONS

The present application is a continuation-in-part of U.S. patent application Ser. No. 10/688,312, entitled SYSTEM AND METHOD FOR ANALYTE MEASUREMENT USING AC PHASE ANGLE MEASUREMENTS (published as US-2004-0157337-A1), the contents of which are hereby incorporated by reference in their entirety.

### TECHNICAL FIELD OF THE INVENTION

The present invention relates to a measurement method and apparatus for use in measuring concentrations of an analyte in a fluid. The invention relates more particularly, but not exclusively, to a method and apparatus which may be used for measuring the concentration of glucose in blood.

### BACKGROUND OF THE INVENTION

Measuring the concentration of substances, particularly in the presence of other, confounding substances, is important in many fields, and especially in medical diagnosis. For example, the measurement of glucose in body fluids, such as blood, is crucial to the effective treatment of diabetes.

Diabetic therapy typically involves two types of insulin treatment: basal, and meal-time. Basal insulin refers to continuous, e.g. time-released insulin, often taken before bed. Meal-time insulin treatment provides additional doses of faster acting insulin to regulate fluctuations in blood glucose caused by a variety of factors, including the metabolization of sugars and carbohydrates. Proper regulation of blood glucose fluctuations requires accurate measurement of the concentration of glucose in the blood. Failure to do so can produce extreme complications, including blindness and loss of circulation in the extremities, which can ultimately deprive the diabetic of use of his or her fingers, hands, feet, etc.

Multiple methods are known for measuring the concentration of analytes in a blood sample, such as, for example, glucose. Such methods typically fall into one of two categories: optical methods and electrochemical methods. Optical methods generally involve reflectance or absorbance spectroscopy to observe the spectrum shift in a reagent. Such shifts are caused by a chemical reaction that produces a color change indicative of the concentration of the analyte. Electrochemical methods generally involve, alternatively, amperometric or coulometric responses indicative of the concentration of the analyte. See, for example, U.S. Pat. No. 4,233,029 to Columbus, U.S. Pat. No. 4,225,410 to Pace, U.S. Pat. No. 4,323,536 to Columbus, U.S. Pat. No. 4,008,448 to Muggli, U.S. Pat. No. 4,654,197 to Lilja et al., U.S. Pat. No. 5,108,564 to Szuminsky et al., U.S. Pat. No. 5,120,420 to Nankai et al., U.S. Pat. No. 5,128,015 to Szuminsky et al., U.S. Pat. No. 5,243,516 to White, U.S. Pat. No. 5,437,999 to Diebold et al., U.S. Pat. No. 5,288,636 to Pollmann et al., U.S. Pat. No. 5,628,890 to Carter et al., U.S. Pat. No. 5,682,884 to Hill et al., U.S. Pat. No. 5,727,548 to Hill et al., U.S. Pat. No. 5,997,817 to Crismore et al., U.S. Pat. No. 6,004,441 to Fujiwara et al., U.S. Pat. No. 4,919,770 to Priedel, et al., and U.S. Pat. No. 6,054,039 to Shieh, which are hereby incorporated by reference in their entireties.

An important limitation of electrochemical methods of measuring the concentration of a chemical in blood is the effect of confounding variables on the diffusion of analyte and the various active ingredients of the reagent. Examples of limitations to the accuracy of blood glucose measurements include variations in blood composition or state (other than the aspect being measured). For example, variations in hematocrit (concentration of red blood cells), or in the concentration of other chemicals in the blood, can effect the signal generation of a blood sample. Variations in the bilirubin content of blood samples is yet another example of a confounding variable in measuring blood chemistry.

With respect to hematocrit in blood samples, prior art methods have relied upon the separation of the red blood cells from the plasma in the sample, by means of glass fiber filters or with reagent films that contain pore-formers that allow only plasma to enter the films, for example. Separation of red blood cells with a glass fiber filter increases the size of the blood sample required for the measurement, which is contrary to test meter customer expectations. Porous films are only partially effective in reducing the hematocrit effect, and must be used in combination with increased delay time and/or AC measurements (see below) to achieved the desired accuracy.

Prior art methods have also attempted to reduce or eliminate hematocrit interference by using DC measurements that include longer incubation time of the sample upon the test strip reagent, thereby reducing the magnitude of the effect of sample hematocrit on the measured glucose values. Such methods also suffer from greatly increased test times.

Thus, a system and method are needed that accurately measure blood glucose, even in the presence of confounding variables, including variations in hematocrit and the concentrations of other chemicals in the blood. A system and method are likewise needed that accurately measure any medically significant component of any biological fluid. It is an object of the present invention to provide such a system and method.

### SUMMARY OF THE DISCLOSED EMBODIMENTS

In one embodiment, a method for determining a concentration of a medically significant component of a biological fluid is disclosed, comprising the steps of: applying a first signal having an AC component to the biological fluid, wherein the AC component has a magnitude sufficient to generate a faradaic current response from the biological fluid; measuring the current response to the first signal; determining a fundamental component of the current response; and determining from the fundamental component an indication of the concentration of the medically significant component.

In another embodiment, a method for determining a concentration of a medically significant component of a biological fluid is disclosed, comprising the steps of: applying a first AC signal to the biological fluid, wherein the first AC signal has a magnitude sufficient to generate a faradaic current response from the biological fluid; measuring the current response to the first AC signal; determining a fundamental component of the current response; and determining from the fundamental component an indication of the concentration of the medically significant component.

In yet another embodiment, a method for determining a glucose concentration of a blood sample is disclosed, comprising the steps of: applying a first signal having an AC component to the blood sample, wherein the AC component has a magnitude sufficient to generate a faradaic current response from the blood sample; measuring the current response to the first signal; determining a fundamental component of the current response; and determining from the fundamental component an indication of the glucose concentration.

### BRIEF DESCRIPTION OF THE DRAWINGS

The invention will be further described, by way of example only, with reference to the accompanying drawings, in which:

FIG. 1 is a plot of potential versus time, showing a prior art excitation signal and response thereto from a prior art electrochemical test strip.

FIG. 2 is a plot of potential versus time, showing a first embodiment excitation potential of the present invention, a faradaic response thereto from an electrochemical test strip, and a fundamental component of the response.

FIG. 3 is plot of the real portion of each first Fourier admittance response component plotted against the imaginary portion of each first Fourier admittance response component according to a method of one embodiment of the present invention.

FIG. 4 is a plot of normalized error versus actual glucose concentration (with hematocrit concentration displayed parametrically) for several glucose concentration measurements made according to one embodiment of the present invention.

FIG. 5 is a plot of actual glucose concentration versus measured glucose concentration for several samples containing 0 mg/dL bilirubin, measured according to one embodiment of the present invention.

FIG. 6 is a plot of actual glucose concentration versus measured glucose concentration for several samples containing 20 mg/dL bilirubin, measured according to one embodiment of the present invention.

FIG. 7 is a plot of actual glucose concentration versus measured glucose concentration for several samples containing 40 mg/dL bilirubin, measured according to one embodiment of the present invention.

FIG. 8 is a table of test data obtained using one embodiment of the present invention and a prior art measurement technique, for several blood samples having 25% hematocrit.

FIG. 9 is a table of test data obtained using one embodiment of the present invention and a prior art measurement technique, for several blood samples having 45% hematocrit.

FIG. 10 is a table of test data obtained using one embodiment of the present invention and a prior art measurement technique, for several blood samples having 65% hematocrit.

FIG. 11 is a plot of glucose concentration versus measured admittance for several blood samples, with the excitation potential harmonic displayed parametrically.

FIG. 12 is a plot of actual glucose concentration versus measured glucose concentration for several blood samples, using the fundamental frequency component of the response.

FIG. 13 is a plot of actual glucose concentration versus measured glucose concentration for the several blood samples used in the plot of FIG. 12, using the fourth harmonic frequency component of the response.

FIG. 14 is a plot of actual glucose concentration versus measured glucose concentration for the several blood samples used in the plot of FIG. 12, using the fifth harmonic frequency component of the response.

FIG. 15 is a plot of normalized error versus reference glucose for several blood samples using a 128 Hz excitation signal in a 0.5 second test.

FIG. 16 is a plot of normalized error versus reference glucose for several blood samples using a 128 Hz excitation signal in a 1.0 second test.

FIG. 17 is a plot of normalized error versus reference glucose for several blood samples using a 128 Hz excitation signal in a 3.0 second test.

FIG. 18 is a plot of normalized error versus reference glucose for several blood samples using a three frequency excitation signal in a 0.5 second test.

FIG. 19 is a plot of normalized error versus reference glucose for several blood samples using a three frequency excitation signal in a 1.0 second test.

FIG. 20 is a plot of normalized error versus reference glucose for several blood samples using a three frequency excitation signal in a 3.0 second test.

FIG. 21 is a plot of normalized error versus reference glucose for several blood samples using a DC excitation signal.

FIG. 22 is a plot of normalized error versus reference glucose for several blood samples using an excitation signal comprising DC and two low potential AC frequencies.

FIG. 23 is a plot of normalized error versus reference glucose for several blood samples using an excitation signal comprising a DC signal, a low potential AC signal, and a high potential AC signal.

FIG. 24 is a plot of normalized error versus reference glucose for several blood samples using a high potential AC excitation signal.

FIG. 25 is a plot of normalized error versus reference glucose for several blood samples using a high potential AC excitation signal and a low potential AC excitation signal having two frequencies.

FIG. 26 is a plan view of an electrode pattern of a symmetrical sensor design utilized for one experiment using the methods described herein.

FIG. 27 is a graph of current response versus glucose concentration for various excitation potentials when using reagent compounds comprising nitrosoananline and derivatives thereof.

### DETAILED DESCRIPTION OF THE VARIOUS EMBODIMENTS

For the purposes of promoting an understanding of the principles of the invention, reference will now be made to the embodiments illustrated in the drawings, and specific language will be used to describe those embodiments. It will nevertheless be understood that no limitation of the scope of the invention is intended. Alterations and modifications in the illustrated device, and further applications of the principles of the invention as illustrated therein, as would normally occur to one skilled in the art to which the invention relates are contemplated, are desired to be protected. In particular, although the invention is discussed in terms of a blood glucose test device and measurement methods, it is contemplated that the invention can be used with devices for measuring other analytes and other sample types. Such alternative embodiments require certain adaptations to the embodiments discussed herein that would be obvious to those skilled in the art.

A system and method according to the present invention permit the accurate measurement of an analyte in a fluid. In particular, the measurement of the analyte remains accurate despite the presence of interferants, which would otherwise cause error. For example, a blood glucose meter according to the present invention measures the concentration of blood glucose without error that is typically caused by variations in the hematocrit level of the sample. The accurate measurement of blood glucose is invaluable to the prevention of blindness, loss of circulation, and other complications of inadequate regulation of blood glucose in diabetics. An additional advantage of a system and method according to the present invention is that measurements can be made much more rapidly, with much smaller sample volumes, and with less complex instrumentation, making it more convenient for the diabetic person to measure their blood glucose. Likewise, accurate and rapid measurement of other analytes in blood, urine, or other biological fluids provides for improved diagnosis and treatment of a wide range of medical conditions.

In the context of systems for measuring glucose, it will be appreciated that electrochemical blood glucose meters typically (but not always) measure the electrochemical response of a blood sample in the presence of a reagent. The reagent reacts with the glucose to produce charge carriers that are not otherwise present in blood. Consequently, the electrochemical response of the blood in the presence of a given signal is intended to be primarily dependent upon the concentration of blood glucose. Secondarily, however, the electrochemical response of the blood to a given signal is dependent upon other factors, including hematocrit and temperature. See, for example, U.S. Pat. Nos. 5,243,516; 5,288,636; 5,352,351; 5,385,846; 5,508,171, and 6,645,368 which discuss the confounding effects of hematocrit on the measurement of blood glucose, and which are hereby incorporated by reference in their entireties. In addition, certain other chemicals can influence the transfer of charge carriers through a blood sample, including, for example, uric acid, bilirubin, and oxygen, thereby causing error in the measurement of glucose.

One embodiment according to the present invention directed to a system and method for measuring blood glucose operates generally by electrochemically analyzing the sample with an applied AC potential having a magnitude large enough to cause significant electrochemical reactions to take place within the electrochemical cell and the generation of a faradaic current response resulting from the AC potential, wherein the method of analysis of the response of the cell consists of a linear analysis of the response data. Even when the cell generates a nonlinear current response to the AC potential, by approximating the harmonics of the applied fundamental frequency, highly useful data for determining the analyte concentration of the biological fluid sample can be found in the fundamental component of that current response (that is, the first harmonic having a frequency that is the same or substantially the same as the fundamental frequency of the applied AC potential). In one embodiment directed to determining the glucose concentration of a blood sample, the measurement and analysis methods disclosed herein yield measured values that are relatively insensitive to the hematocrit and other interferents within the blood sample.

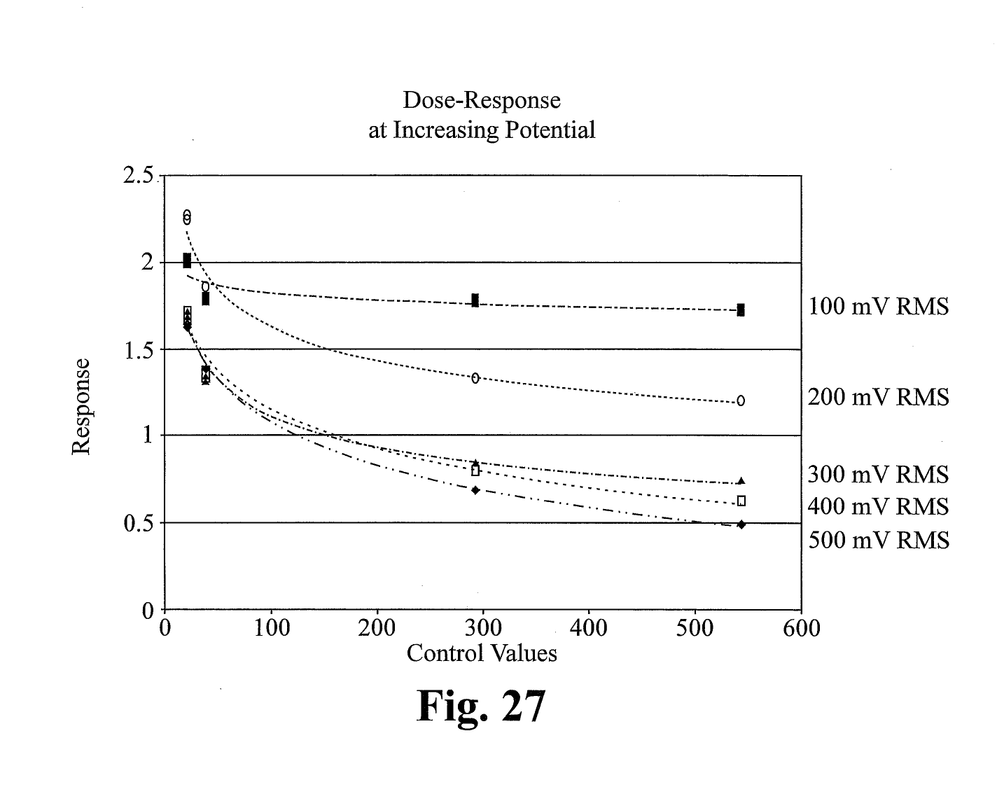

As disclosed in pending U.S. application Ser. No. 10/688,312 (US Application Publication 2004/0157337) which is hereby incorporated by reference herein in its entirety, the phase angle of the current response to an AC signal of relatively low frequency and low potential may be used to obtain information about the analyte content of a fluid sample in the presence of a reagent containing an easily reversible redox mediator such as potassium ferricyanide. For example, with that particular reagent in the sensor, an applied DC potential difference, such as about 300 mV, is suitable to generate a faradaic response in a bi-amperometric measurement. Similarly, an applied AC potential, for example about 56.56 mV rms, is sufficient to generate a faradaic current response. It has also been noted that different reagent compounds, such as nitrosoanaline and derivatives thereof, may be used in amperometric sensors. See, e.g., U.S. Pat. Nos. 5,122,244 and 5,286,362, and pending U.S. Patent Applications US-2005-0013731-A1, US-2005-0016844-A1, US-2005-0008537-A1, and US-2005-0019212-A1, all incorporated by reference herein in their entireties. In sensors with these reagents, a relatively larger DC potential difference, such as 450 to 550 mV, should suitably be applied to the sensor to generate a faradaic current response in a bi-amperometric measurement. Referring to FIG. 27, according to one set of experimental data, DC potentials ranging from about 200 mV to about 500 mV are sufficient to generate a faradaic current response in a bi-amperometric measurement system using reagent compounds comprising nitrosoananline and derivatives thereof. Similarly, a relatively larger AC potential, such as 300 mV rms, should suitably be applied to a sensor using reagent compounds comprising nitrosoananline and derivatives thereof to generate a suitable faradaic response. By varying the magnitude of the applied AC signal and determining the characteristics of the AC response, it is possible for one skilled in the art of electrochemical sensors, in conjunction with the teachings contained herein, to determine the preferred potential for any particular reagent that is included in the sensor. Thus, different reagents may require different applied potential thresholds to generate a useful faradic current response.

As used herein, a low potential AC excitation refers to an applied AC potential that is insufficient to generate a faradaic current response, whereas a high potential AC excitation refers to an applied AC potential that is sufficient to generate a faradaic current response, in each case depending upon the particular reagent employed. It will be noted that in some circumstances, a faradaic reaction in response to a given high potential AC excitation will cause the response to have non-linear characteristics, i.e. an applied sinusoidal wave form will create a non-sinusoidal response.

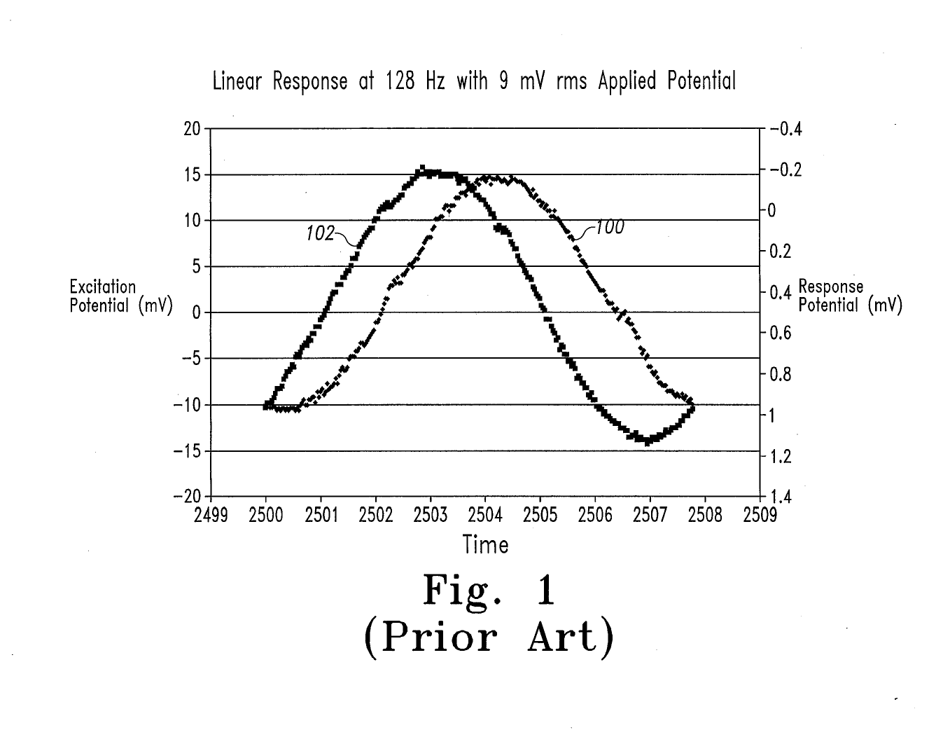

With reference to FIG. 1, a test was conducted using an electrochemical test strip built in accordance with the disclosure of co-pending U.S. Published Patent Application US-2005-0013731-A1, cited above. Namely, the electrochemical test strips used for conducting the tests disclosed throughout this application comprised the ACCU-CHEK® AVIVA™ test strip manufactured and distributed by Roche Diagnostics Corporation, Indianapolis, Ind.

Measurements were conducted with an electrochemical test stand constructed on the basis of VXI components from Agilent, and programmable to apply AC and DC potentials to sensors in requested combinations and sequences and to measure the resulting current responses of the sensors. Data were transferred from the electrochemical analyzer to a desktop computer for analysis using Microsoft® Excel®. The measurements could be carried out by any commercially available programmable potentiostat with an appropriate frequency response analyzer and digital signal acquisition system. For commercial use, the method can be carried out in a dedicated low-cost hand-held measurement device, such as the ACCU-CHEK® AVIVA™ blood glucose meter. In such a case the measurement parameters may be contained in or provided to the firmware of the meter, and the measurement sequence and data evaluation executed automatically with no user interaction. For example, using a programmable potentiostat as described above, measurements were conducted and results analyzed in a manner such that results could be processed, made available and/or displayed to a user within about 4 seconds, about 2 seconds, or as low as about 1 second after the analyte-containing sample was applied to a biosensor and detected by the equipment. Similarly, the firmware of the ACCU-CHEK® AVIVA™ blood glucose meter may be provided with measurement parameters configured and arranged to cause the measurement sequence, data evaluation and result display to occur within the same time periods, namely about 4, about 2, or as low as about 1 second after a sample is dosed and its contact with the reagent compound is detected by the meter.

In FIG. 1, there is shown a first plot of potential versus time, illustrating the AC excitation potential 100 that is applied to the electrochemical test strip with a whole blood sample applied thereto. This is typical of prior art low potential AC excitations chosen so as not to excite electrochemical processes on the test strip electrodes, that is, insufficient to generate a faradaic current response. The excitation potential 100 was a 128 Hz sinusoid at a voltage of 9 mV rms. The measured response of the test strip to this excitation is also illustrated at 102. As can be seen, the response 102 is linear and retains the frequency content and sinusoidal shape of the excitation potential 100 with the expected phase shift.

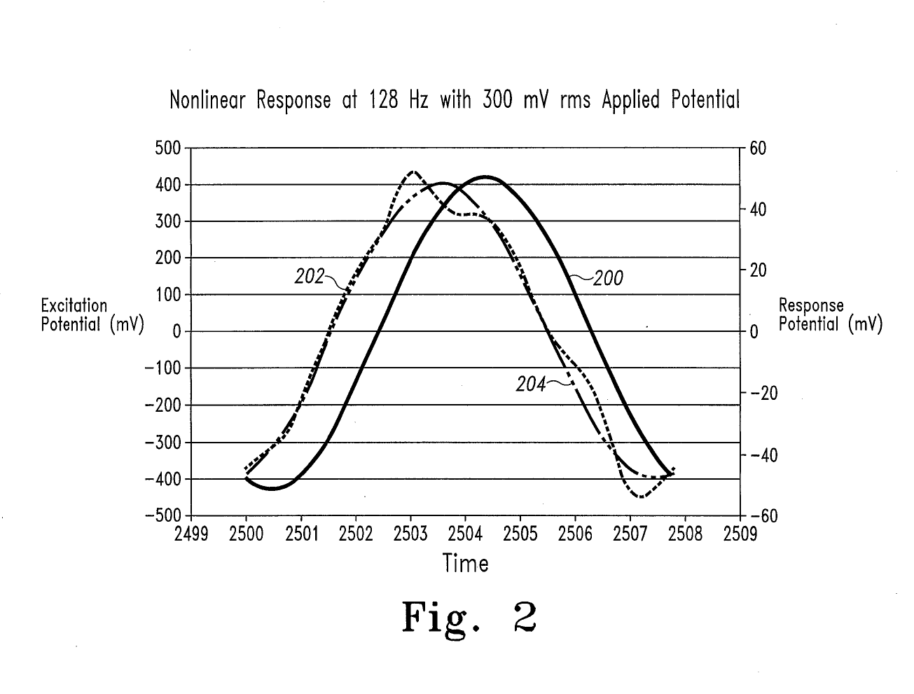

FIG. 2 is a second plot of potential versus time, illustrating a first embodiment excitation potential 200 of the present invention applied to the same type of electrochemical test strip and blood sample composition used to generate the data illustrated in FIG. 1. The excitation potential 200 was also a 128 Hz sinusoid, however the excitation voltage was 300 mV rms, which is a high potential AC excitation, sufficient to generate electrochemical processes on the test strip electrode and a faradaic current response with this particular test strip architecture and reagent composition. Evidence of such electrochemical processes is provided by the current response 202 measured on the test strip. It will be noted that the response 202 does not retain the purely sinusoidal shape of the excitation potential, but instead exhibits a nonlinear shape caused by the presence of higher order harmonics mixed in with a fundamental component of the same or substantially the same frequency as the AC excitation frequency.

Various embodiments as disclosed herein make use of an analysis of the fundamental component of the non-linear current response in order to accurately determine the analyte concentration of the sample, substantially free from the effects of interfering substances in the sample. In one embodiment, the response 202 is measured as admittance values and the components of the response 202 are obtained, such as by performing a Fourier transform upon the response 202 data, which will yield the first Fourier component 204 illustrated in FIG. 2. It will be appreciated by those skilled in the art that the first Fourier component represents the fundamental component of the current response 202 (i.e. the component of the response 202 having the same or substantially the same frequency as the AC excitation frequency), and may be obtained in any one of a number of methods known in the art, such as by means of a Fast Fourier Transform (FFT), or discreet Fourier Transform (DFT).

Once the fundamental component of the current response of the sensor has been determined, it is possible to calculate the Impedance or its inverse, the Admittance, of the sensor, from the fundamental component, the excitation potential, and the vector form of Ohm's law (E=IZ). In this case, the quantities E (potential), I (current), and Z (Impedance), are vector quantities with a magnitude and a direction. The Impedance vector is frequently analyzed by referring to its magnitude and phase angle. From the vector form of Ohm's law, the phase of the Impedance is the angle between the potential vector (E) and the current vector (I).

The Admittance is also a vector with a magnitude and a direction. It is sometimes convenient to analyze vectors as ordered pairs in Cartesian coordinates instead of according to magnitude and direction. For this purpose the X axis of the normal Cartesian coordinate plane represents the real axis, and values plotted along this axis are referred to as the real component of the Impedance or the Admittance, or sometimes the in-phase component. Similarly, values plotted along the Y axis are referred to as the imaginary components or the out-of-phase components.

Electrochemical Impedances are sometimes analyzed according to equivalent circuit models. This is a theoretical collection of electrical components, which, if constructed and subjected to the same excitation signal, would have the same Impedance as the electrochemical system under investigation. Because analytical electrochemical systems are not ideal electrical components, some of the components of an equivalent circuit model are not real electrical components, such as resistors and capacitors, but mathematical descriptions such as Warburg elements for diffusion and Constant Phase Elements to account for non-ideality in electrode surfaces. An equivalent circuit model for a typical biosensor test strip is discussed in U.S. Pat. No. 6,645,368, which is hereby incorporated herein by reference in its entirety. An equivalent circuit model of the ACCU-CHEK® AVIVA™ sensor was made to assist in evaluating the Impedance data from the measurement method described.

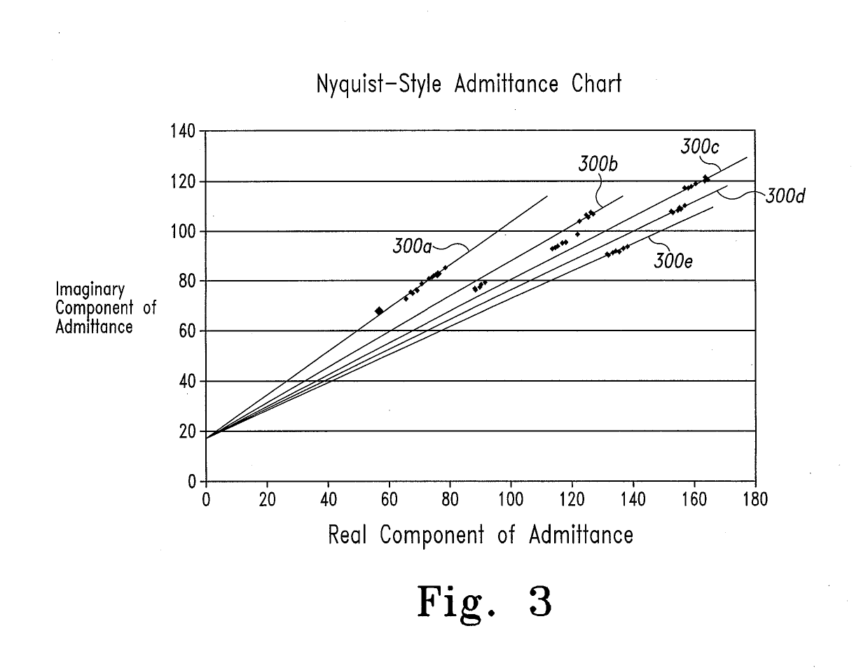

FIG. 3 illustrates the real portion of the Admittance (Yᵣₑₐₗ) for the fundamental component plotted versus the imaginary portion of the Admittance (Y_{imag}) for the fundamental component from the analysis of seven blood samples, each having a different glucose level. The real and imaginary portions are calculated from the measured Admittance magnitude and phase angle using the relationships expressed in equations 1 and 2.
Yᵣₑₐₗ−Y_{mag}*cos(Yₚₕₐₛₑ) (equation 1)
Y_{imag}=Y_{mag}*sin(Yₚₕₐₛₑ) (equation 2)
where:
Y_{mag} is the magnitude of the measured admittance;
Yₚₕₐₛₑ is the phase angle of the measured admittance;
Yᵣₑₐₗ is the real portion of the measured admittance; and
Y_{imag} is the imaginary portion of the measured admittance.

As illustrated by the fit lines 300a through 300e drawn for five of the seven data clusters, there is a very high correlation between the real and imaginary components of the fundamental component when the sample is excited by a high potential AC excitation. Furthermore, all of the lines 300a through 300e converge at the same point. The slope of each of the lines 300a through 300e is related to the glucose value of the test sample that generated the data. If the convergence intercept were ideally at the origin (0,0), then the parameter that corresponds to the glucose value of the test sample would be the tangent of the phase angle of the fundamental component of the current response to the AC excitation signal. However, since the intercept in the system from which these results were obtained is not the origin, the glucose value is more accurately calculated as a function of the phase angle of the fundamental component of the current response to the AC excitation signal, offset to a different origin, as expressed in equation 3
glucose=F((Yᵢ−Yᵢ₀)/(Yᵣ−Yᵣ₀)) (equation 3)

where:
Yᵢ is the imaginary portion of the Admittance response of the fundamental component of the current response;
Yᵢ₀ is the imaginary portion of the offset intercept (Yᵢ₀,Yᵣ₀);
Yᵣ is the real portion of the Admittance response of the fundamental component of the current response; and
Yᵣ₀ is the real portion of the offset intercept (Yᵢ₀,Yᵣ₀).

Changing the origin of the coordinate system, i.e. determining the offset intercept for a particular analytical system, corresponds to removing components from the equivalent circuit model that are not interesting for the analyte in question. For example, with the ACCU-CHEK® AVIVA™ model, the Impedance of the solution resistance component and the Impedance of the electrode capacitance component are removed from the equivalent circuit model of the sensor, leaving only the Impedances due to the faradaic and diffusion processes of the sensor. These values may be determined empirically by analyzing data collected from sensors with different samples. The values may then be used to analyze data from other sensors with the same configuration, reagent, and sample types. The offset intercept typically is dependent on sensor geometry and reagent factors; however, this intercept can be assumed to be fixed for each particular sensor and reagent configuration. Alternatively, the offset can be determined by examining data collected at other potentials or other frequencies, such as high frequency low potential AC measurements carried out in addition to the low frequency high potential measurement, before or after, or simultaneously.

An appropriate new origin of the coordinate system can also be determined empirically, as illustrated in this example. That is, the data points for a sensor experiment may be plotted on coordinate axes, and lines drawn to determine the best common intersection point. This point may then be used to analyze data from other sensors with the same configuration, reagent, and sample types.

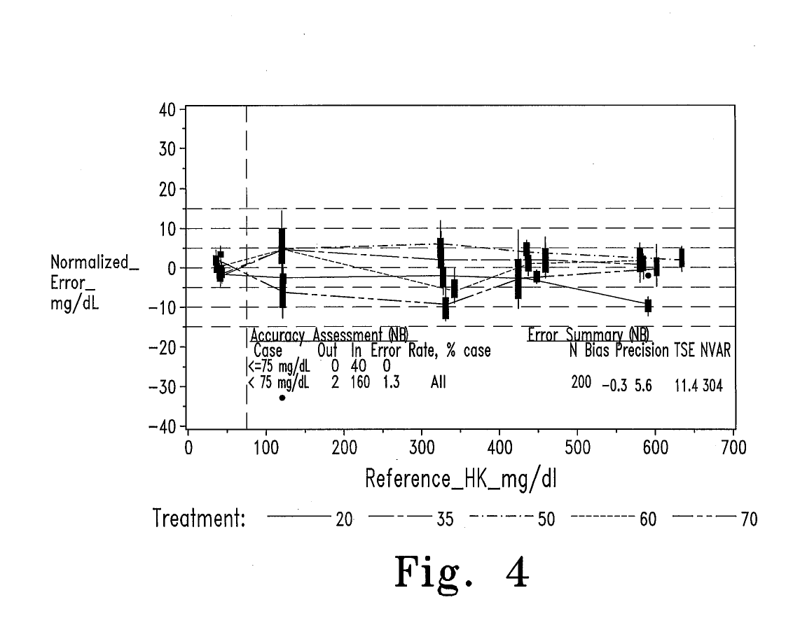

FIG. 4 illustrates glucose data obtained using the method of equation (3) from a covariate test of blood samples having five different hematocrit levels (approximately 20, 35, 50, 60 and 70%) and five different glucose levels (approximately 35, 120, 330, 440 and 600 mg/dL). Using the methodology disclosed herein, the blood samples were applied to a test strip containing a reagent chemistry and subjected to an excitation potential large enough to cause a faradaic current response. From the fundamental component of the current response data, real and imaginary components of the admittance were plotted as described in reference to FIG. 3, and the predicted glucose values of the samples were calculated as described above with respect to equation (3). In FIG. 4, normalized glucose error is plotted versus the actual glucose concentration of the test sample, with sample hematocrit concentration being displayed parametrically. As can be seen, the method of the present invention produces very little spread of the normalized error of the reported glucose levels with changes in hematocrit concentration, indicating that the method is relatively insensitive to hematocrit concentration in the sample. All but two of the 200 data points plotted in FIG. 4 were within +/−15 mg/dL of the true glucose concentration.

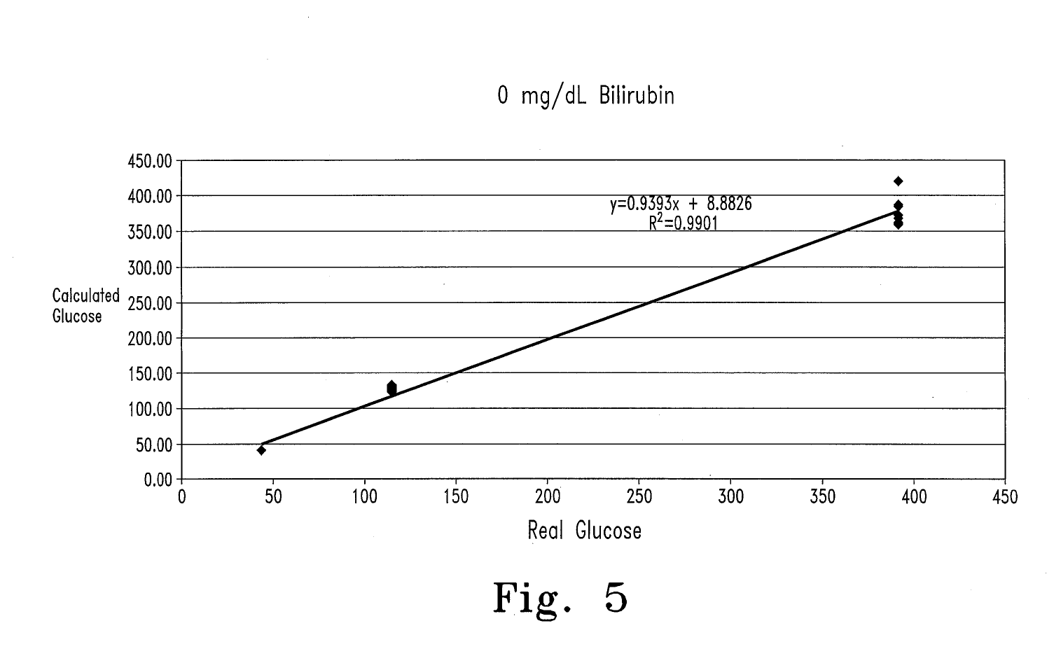

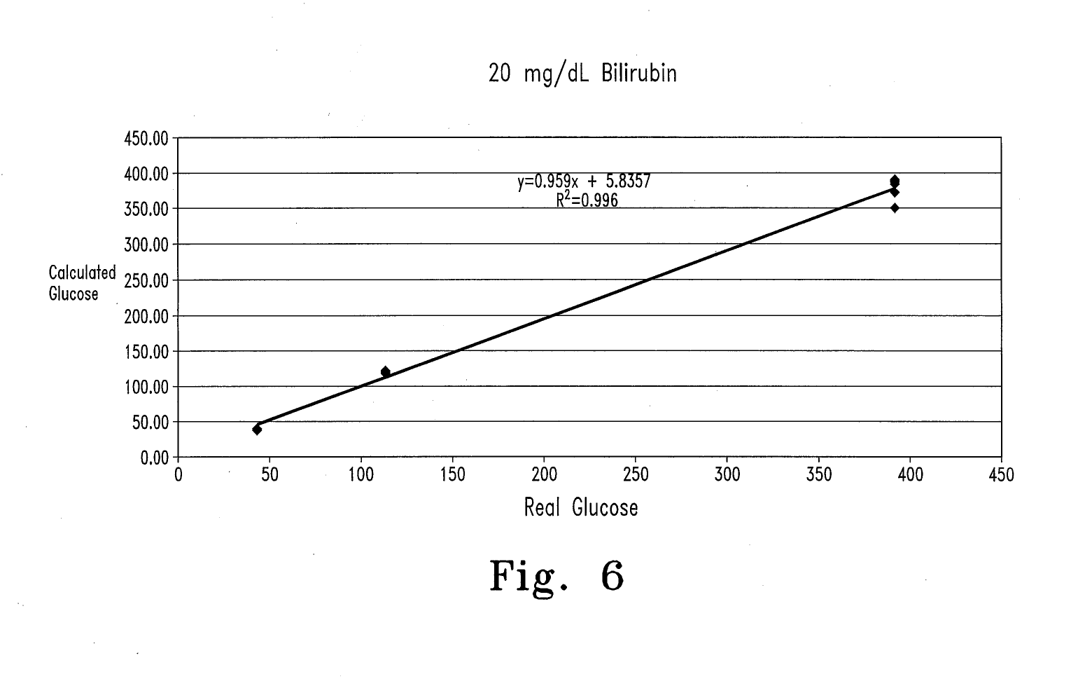

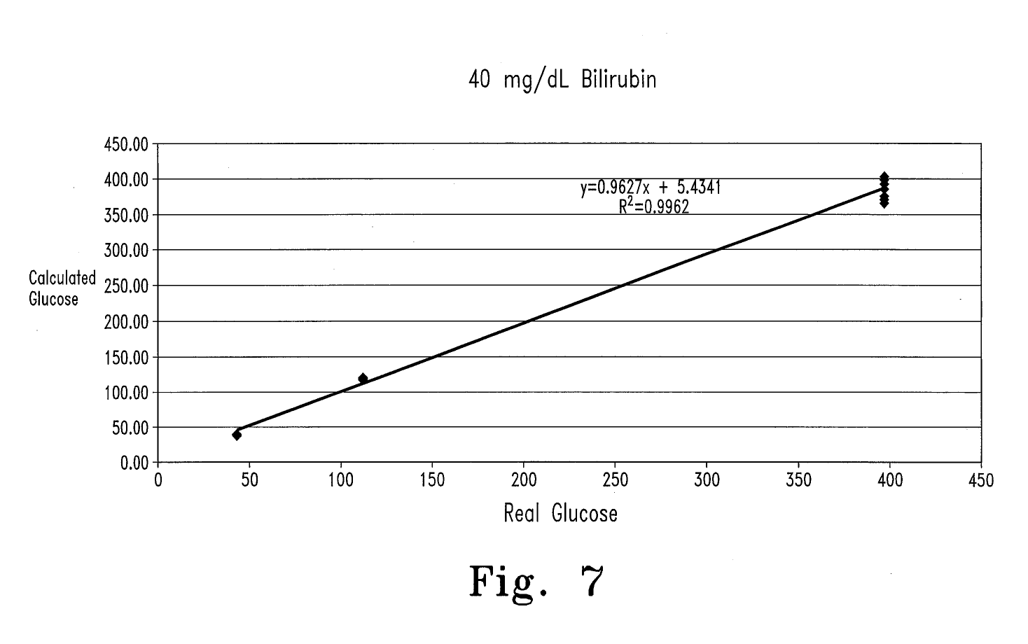

The systems and methods embodying the present invention as disclosed herein are also relatively insensitive to other interferents that commonly reduce the accuracy of glucose tests on whole blood samples. For example, the method described hereinabove was used to measure glucose concentrations in a covariate study of whole blood samples having three different glucose concentrations (40, 120 and 450 mg/dL) and three different bilirubin concentrations (0, 20 and 40 mg/dL). FIG. 5 illustrates the results of the study for the samples having 0 mg/dL bilirubin, showing the actual glucose concentration plotted versus the glucose concentration measured and calculated using the method disclosed hereinabove. As can be seen, the R² correlation coefficient is 0.9901. FIG. 6 illustrates the results of the study for the samples having 20 mg/dL bilirubin, showing the actual glucose concentration plotted versus the glucose concentration measured and calculated using the method disclosed hereinabove. As can be seen, the R² correlation coefficient is 0.996. Finally, FIG. 7 illustrates the results of the study for the samples having 40 mg/dL bilirubin, showing the actual glucose concentration plotted versus the glucose concentration measured and calculated using the method disclosed hereinabove. As can be seen, the R² correlation coefficient is 0.9962. As will be apparent to those skilled in the art, bilirubin concentration is essentially eliminated as an interferent when using the systems and methods of the present invention. Thus, the systems and methods of the present invention are useful for blood samples with potentially high bilirubin concentrations, such as neonatal samples.

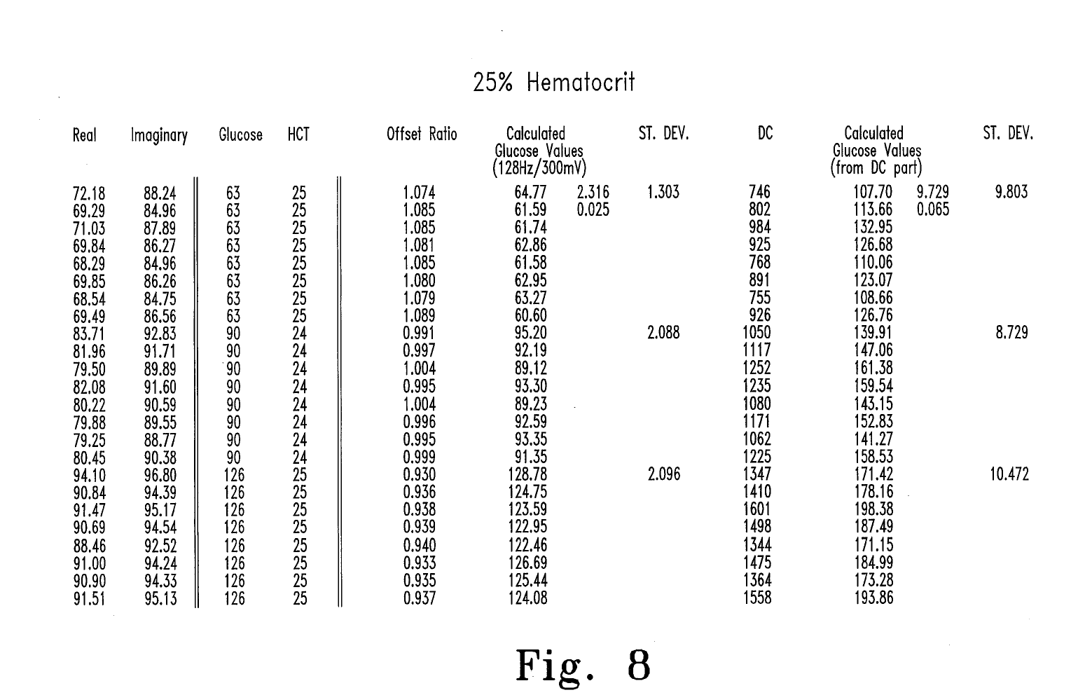

In another study using whole blood samples and ACCU-CHEK® AVIVA™ sensors, embodiments of the systems and methods of the present invention were compared to standard (prior art) DC amperometry glucose measurements for samples having relatively low glucose levels. A covariate study was performed using samples having three different target glucose levels (ranging from 63 mg/dL to 128 mg/dL) and three different target hematocrit levels (25%, 45% and 65%). For each sample, the glucose concentration was measured using the systems and methods described herein, as well as standard prior art Cottrellian DC amperometric techniques. The results of the tests are tabulated in FIGS. 8-10.

In FIG. 8, three samples having glucose levels of 63 mg/dL, 90 mg/dL and 126 mg/dL and a target hematocrit of 25% were tested using the systems and methods described herein, as well as by a prior art Cotrellian DC amperometric technique. The tests using the systems and methods embodying the present invention were carried out at 128 Hz and with a sinusoidal excitation potential of 300 mV rms, and yielded calculated glucose levels that varied from actual by a maximum error of 5.2 mg/dL with standard deviations ranging from 1.303 to 2.096. By contrast, the prior art DC tests yielded calculated glucose levels that varied from actual by a maximum error of 72.38 mg/dL with standard deviations ranging from 9.803 to 10.472.

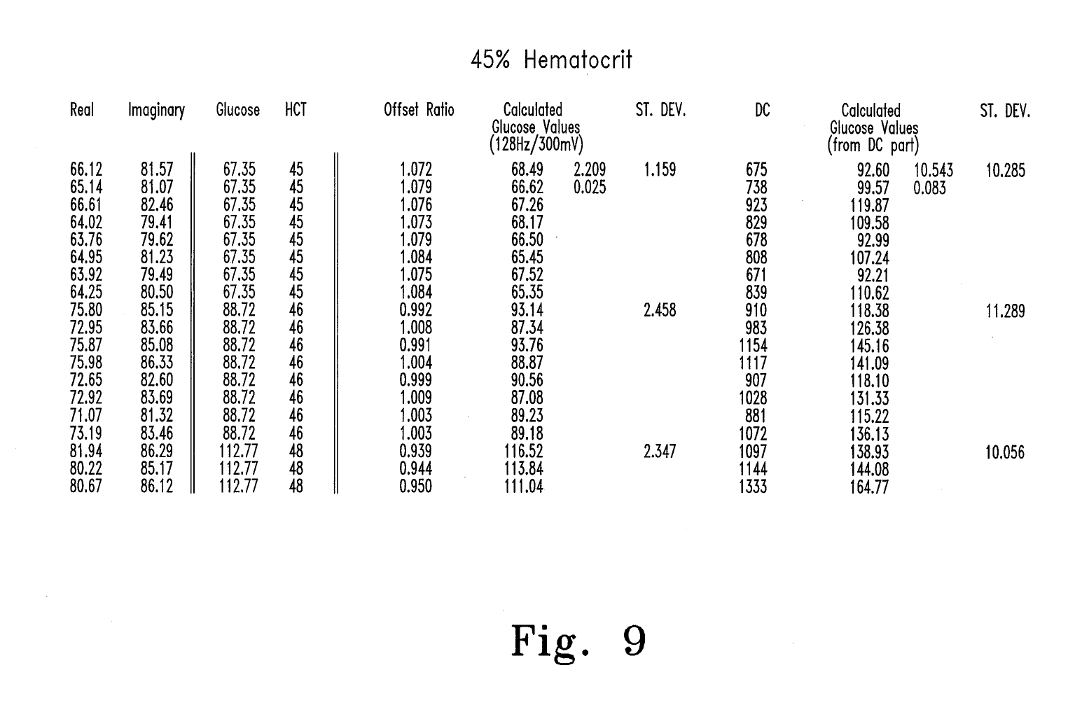

In FIG. 9, three samples having glucose levels of 67 mg/dL, 89 mg/dL and 113 mg/dL and a target hematocrit of 45% were tested using the systems and methods described herein, as well as by a prior art Cotrellian DC amperometric technique. The tests using the systems and methods of the present invention were carried out at 128 Hz and with a sinusoidal excitation potential of 300 mV rms, and yielded calculated glucose levels that varied from actual by a maximum error of 5.04 mg/dL with standard deviations ranging from 1.159 to 2.347. By contrast, the prior art DC tests yielded calculated glucose levels that varied from actual by a maximum error of 56.44 mg/dL with standard deviations ranging from 10.056 to 11.289.

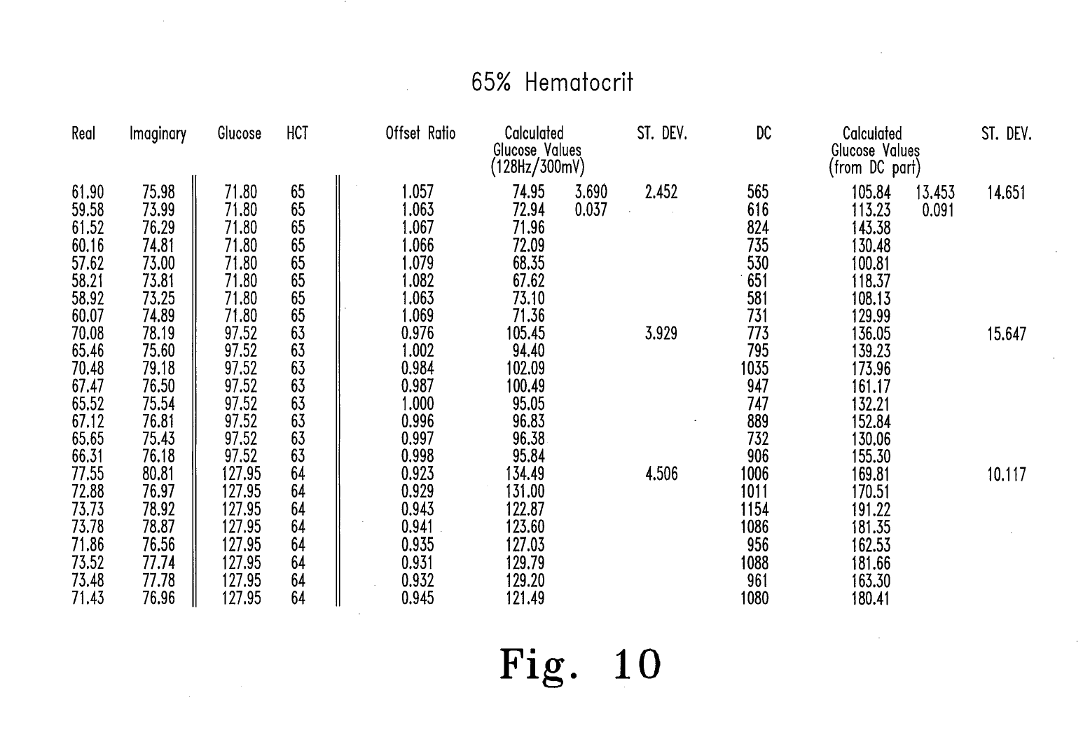

In FIG. 10, three samples having glucose levels of 72 mg/dL, 98 mg/dL and 128 mg/dL and a target hematocrit of 65% were tested using the systems and methods described herein, as well as by a prior art Cotrellian DC amperometric technique. The tests using the systems and methods of the present invention were carried out at 128 Hz and with a sinusoidal excitation potential of 300 mV rms, and yielded calculated glucose levels that varied from actual by a maximum error of 7.93 mg/dL with standard deviations ranging from 2.452 to 4.506. By contrast, the prior art DC tests yielded calculated glucose levels that varied from actual by a maximum error of 76.44 mg/dL standard deviations ranging from 10.117 to 15.647. Clearly, the systems and methods of the present invention offer significant improvements in accuracy (maximum error) and consistency (standard deviation) over the prior art technique.

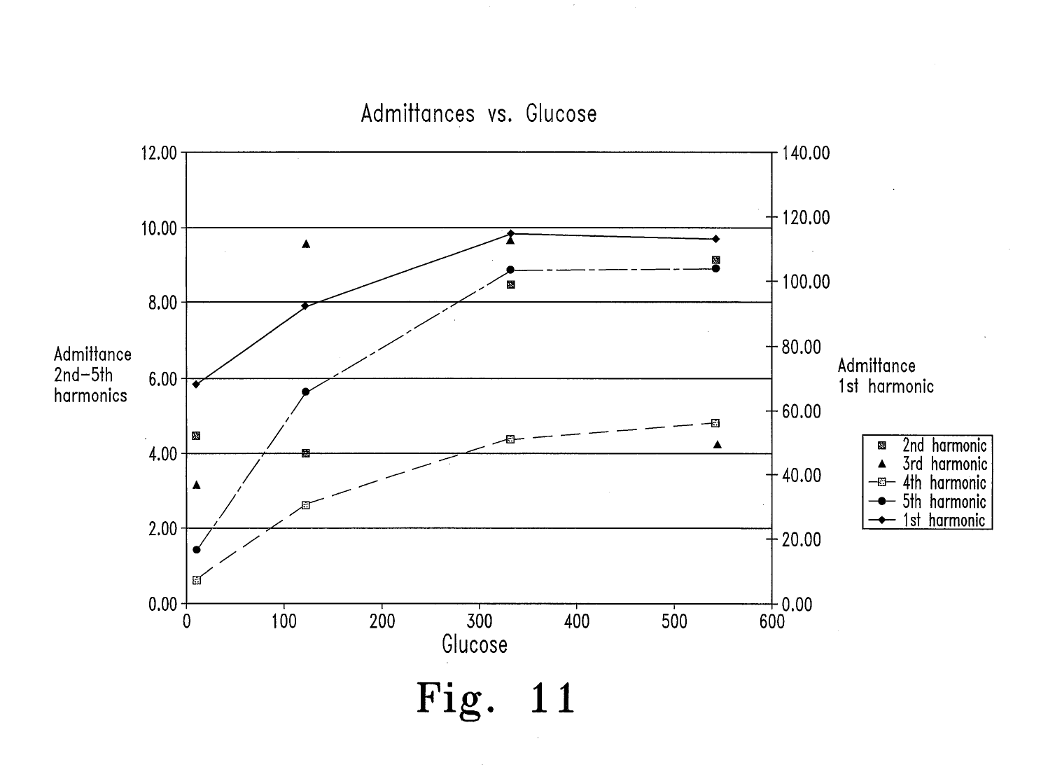

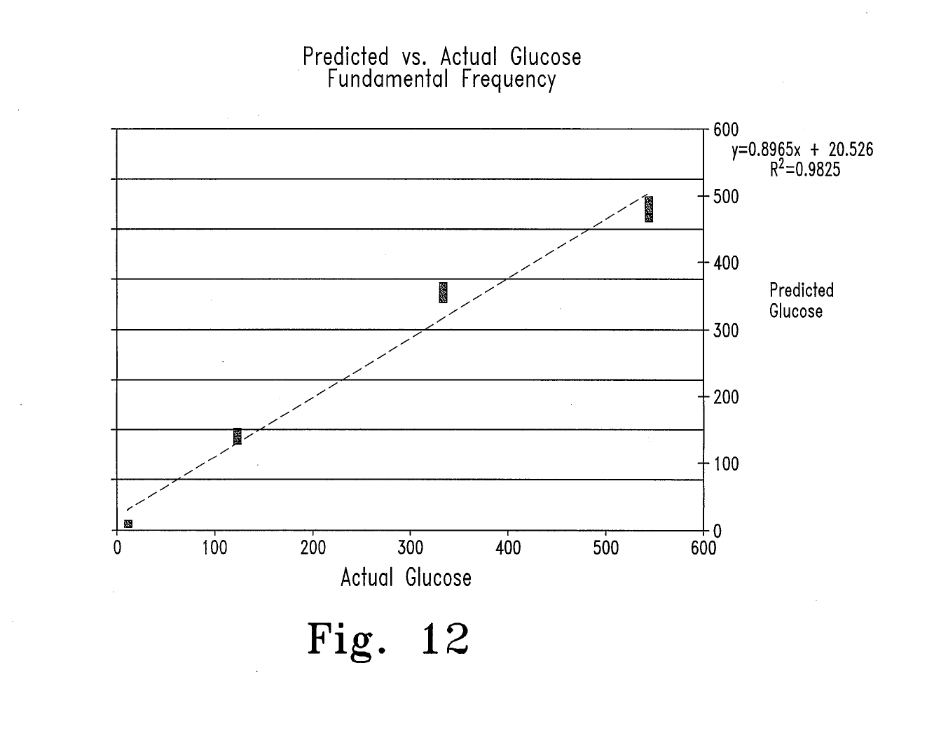

Experiments were also performed in order to compare systems and methods embodying the present invention to glucose calculations made from the higher order harmonics of the current response. Again using ACCU-CHEK® AVIVA™ sensors, samples having glucose levels of 11 mg/dL, 122 mg/dL, 333 mg/dL and 543 mg/dL were subjected to a sinusoidal excitation potential of 300 mV rms at a frequency of 128 Hz, which was sufficiently high to generate a faradaic current response from the test sample. FIG. 11 plots the admittance of the samples measured at the fundamental frequency and at the second through fifth harmonic frequencies for each of the four glucose levels. As can be seen from the graph, only the fundamental, fourth harmonic and fifth harmonic showed a dependency between glucose level and measured admittance, so each of these data sets were studied in greater detail, as shown in FIGS. 12-14.

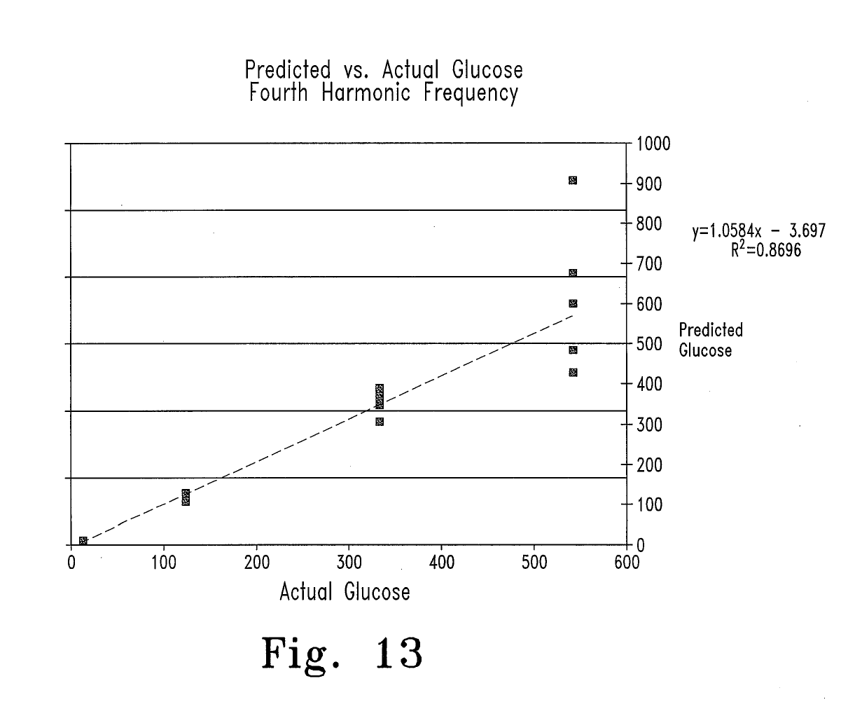

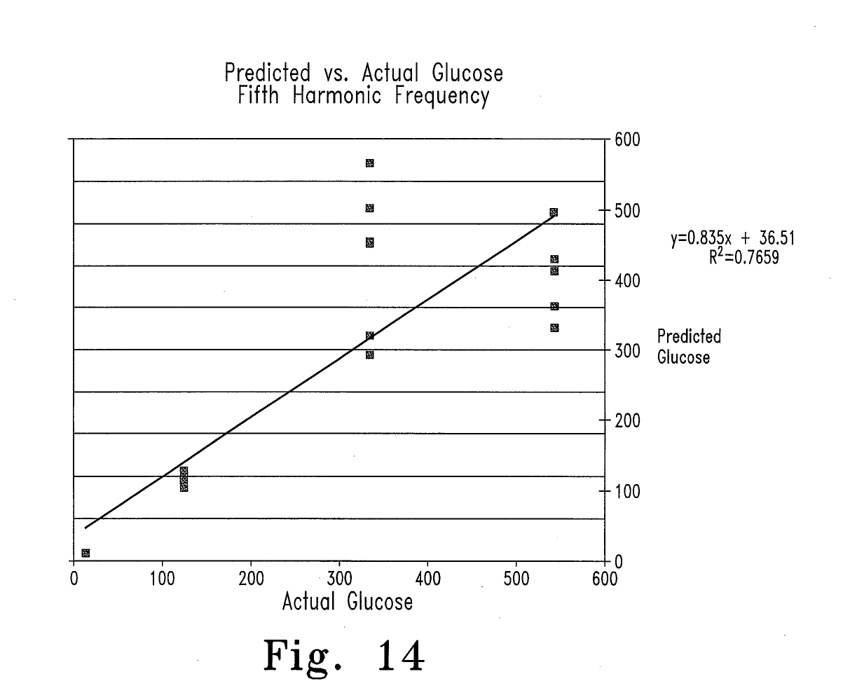

From these experiments, it is clear that although using the fundamental component in the systems and methods as described above provides very high accuracy, in systems in which the faradaic current response is non-linear, other harmonic components may also be used in such systems and methods in order to provide relatively accurate calculations of analyte concentration. Thus, in a glucose measurement system using the chemistry and configuration of an ACCU-CHEK® AVIVA™ sensor, the fourth and fifth harmonics may also be used. In other analyte systems or in other glucose systems using different sensor configurations, other harmonics may be similarly useful. Also clear, as will be seen in the discussions of FIGS. 13 and 14 below, is that there is reduced accuracy, particularly above a certain analyte concentration, which may detract from the practicality of using the harmonics instead of the fundamental component. Nevertheless, use of the harmonics does indeed provide useful results under qualified circumstances and should also be considered an embodiment of the present invention.

FIG. 12 plots the actual glucose values versus the predicted glucose values (calculated using systems and methods embodying the present invention, using the fundamental frequency data). As can be seen, the technique of the present invention provides very accurate predicted glucose levels, with a correlation coefficient (R²) of 0.9825. This is so at low as well as high actual glucose values.

FIG. 13 plots the actual glucose values versus the predicted glucose values (calculated using systems and methods embodying the present invention, using the fourth harmonic frequency data). As can be seen, use of the fourth harmonic data with the technique of the present invention seriously degrades the accuracy of the predicted glucose levels, with the correlation coefficient (R²) dropping to 0.8696. Nevertheless, although the overall accuracy is reduced, it appears that accuracy remains high between lower actual glucose values through 333 mg/dL samples.

FIG. 14 plots the actual glucose values versus the predicted glucose values (calculated using systems and methods embodying the present invention, using the fifth harmonic frequency data). As can be seen, use of the fifth harmonic data with the technique of the present invention seriously degrades the accuracy of the predicted glucose levels even below that obtained using the fourth harmonic, with the correlation coefficient (R²) dropping to 0.7659. Nevertheless, similar to the data for the fourth harmonic, although the overall accuracy is reduced, it appears that accuracy remains high at lower actual glucose values.

As will be appreciated from the foregoing, the systems and methods of the present invention provide highly accurate measurements of analytes in biological fluid samples. The systems and methods of the present invention are particularly useful for the measurement of glucose concentration in blood samples. The most accurate systems and methods embodying the present invention utilize the fundamental frequency component of a current response generated from the test sample when an excitation potential large enough to produce a faradaic response is applied to the sample. While the measurements described in detail hereinabove were carried out at 300 mV rms and 128 Hz, it will be appreciated that the excitation signal magnitude and frequency most useful for any given measurement will be determined by many factors, including the physical test strip (biosensor) design and the choice of reagent used on the test strip. Selection of the most useful potential and frequency for a particular sensor and reagent is an optimization easily accomplished by one skilled in the art without undue experimentation, in light of the direction set forth throughout this disclosure.

Also, it will be appreciated by those skilled in the art that the alternating applied potential may have many forms besides the pure sinusoidal signal used for the tests described hereinabove. As used herein, the phrase “a signal having an AC component” refers to a signal which has some alternating potential (voltage) portions. For example, the signal may be an “AC signal” having 100% alternating potential (voltage) and no DC portions; the signal may have AC and DC portions separated in time; or the signal may be AC with a DC offset (AC and DC signals superimposed). Furthermore, an AC portion may include multiple frequencies applied in sequence, separated in time or immediately sequenced, and even applied simultaneously as a multi-frequency signal.

Regarding the latter, the systems and methods described herein are also useful when measuring analyte concentrations in fluid samples with multiple AC excitations. For example, an additional experiment was performed in order to demonstrate the usefulness of the methods disclosed herein in combination with the methods disclosed in co-pending published U.S. patent applications US-2004-0157339-A1, US-2004-0157337-A1, 2004/0157338-A1, US-2004-0260511-A1, US-2004-0256248-A1 and US-2004-0259180-A1 in order to achieve an accurate measurement result in a very short time. This additional experiment also demonstrated the usefulness of the methods disclosed herein to achieve accurate results with a combined multi-frequency AC excitation waveform without a DC offset imposed on the AC excitation, which allows not only short measurement times, but also adaptive measurement sequences, since the AC signal collection does not permanently alter the sensed chemistry in the way that a DC measurement does because of the alternating polarity of the applied excitation. Moreover, the additional frequencies of the AC signals are applied at low excitation AC potentials, per the methods disclosed in co-pending published U.S. patent applications US-2004-0157339-A1, US-2004-0157337-A1, 2004/0157338-A1, US-2004-0260511-A1, US-2004-0256248-A1 and US-2004-0259180-A1, in order to generate a non-faradaic current response from which a phase angle provides an indication of certain interfering factors, from which indication a determination of one or more interferent corrections can be made and used for more accurately determining the analyte concentration in the fluid sample.

In this experiment, whole blood samples having six different glucose target concentrations (30, 60, 90, 250, 400 and 600 mg/dL) and three different hematocrit target concentrations (25%, 45% and 65%) were analyzed in a covariate study. A simultaneous multi-frequency excitation waveform was created by summing sine waves of one period at 300 mV rms, 10 periods at 9 mV rms, and 100 periods at 9 mV rms. This gave three frequencies to be used for the analysis with a frequency ratio of 1/10/100. This excitation signal was applied to the sensors at a 128 Hz repetition rate, thus the frequencies applied and available for analysis at the fundamental frequency were 128 Hz, 1280 Hz and 12800 Hz. Data were collected at 100 ms intervals. 100 ms intervals of data ending at 500 ms, 1000 ms and 3000 ms were analyzed.

First, the 128 Hz fundamental frequency data were extracted from the measured data using DFT (Discrete Fourier Transform). This data was analyzed using the same methodology discussed above. That is, the real and imaginary components of the Admittance were calculated and plotted against each other, an offset intercept from the natural origin was determined so that the data converged to a single point, and the slope of the line connecting the offset point and the data set was determined. To accommodate the analysis software used in the experiments, this value was transformed by the equation
K=90−Arctan(slope) (Equation 4)
to create a positive valued parameter which increases with increasing glucose. After creating a calibration curve for glucose from the model
Glucose=Intercept+Slope*(K)ˆPower (Equation 5)
by nonlinear fit of the parameters Intercept, Slope and Power, the predicted glucose values were calculated for each measured sample and a total system error (TSE) was calculated for each time point, as will be appreciated by those skilled in the art.

The data from the other frequencies having low potential AC excitation was also extracted from the original signal using DFT. The magnitude and phase of the Admittances were calculated and used in the calibration model in the same way as discussed hereinabove.

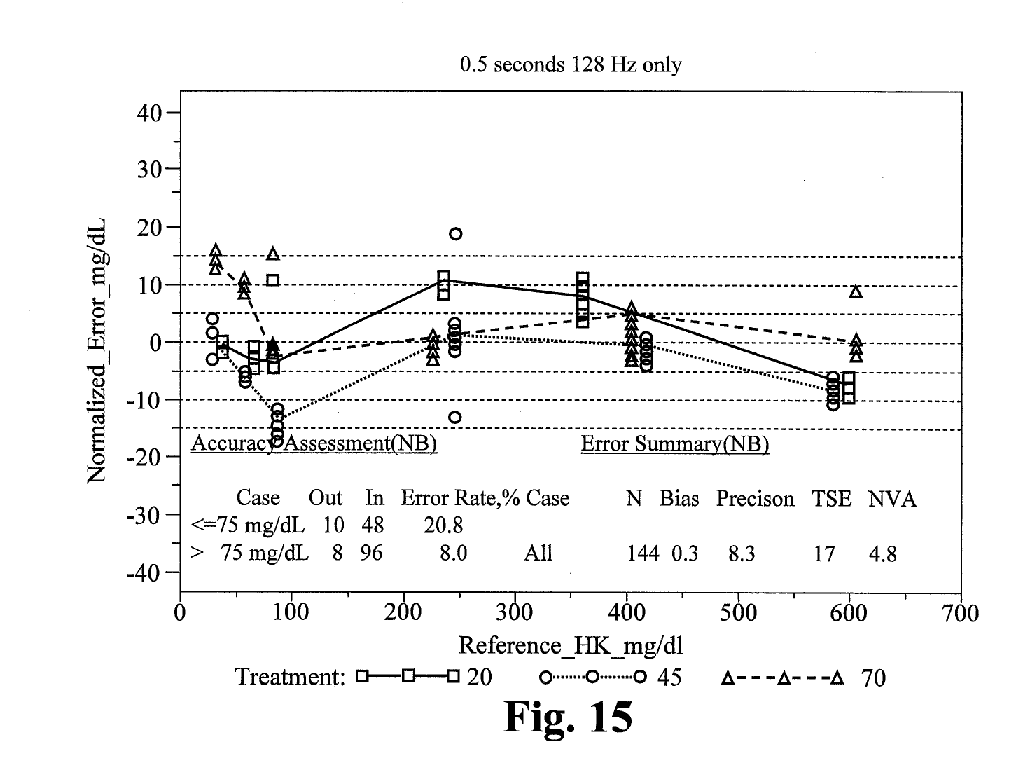

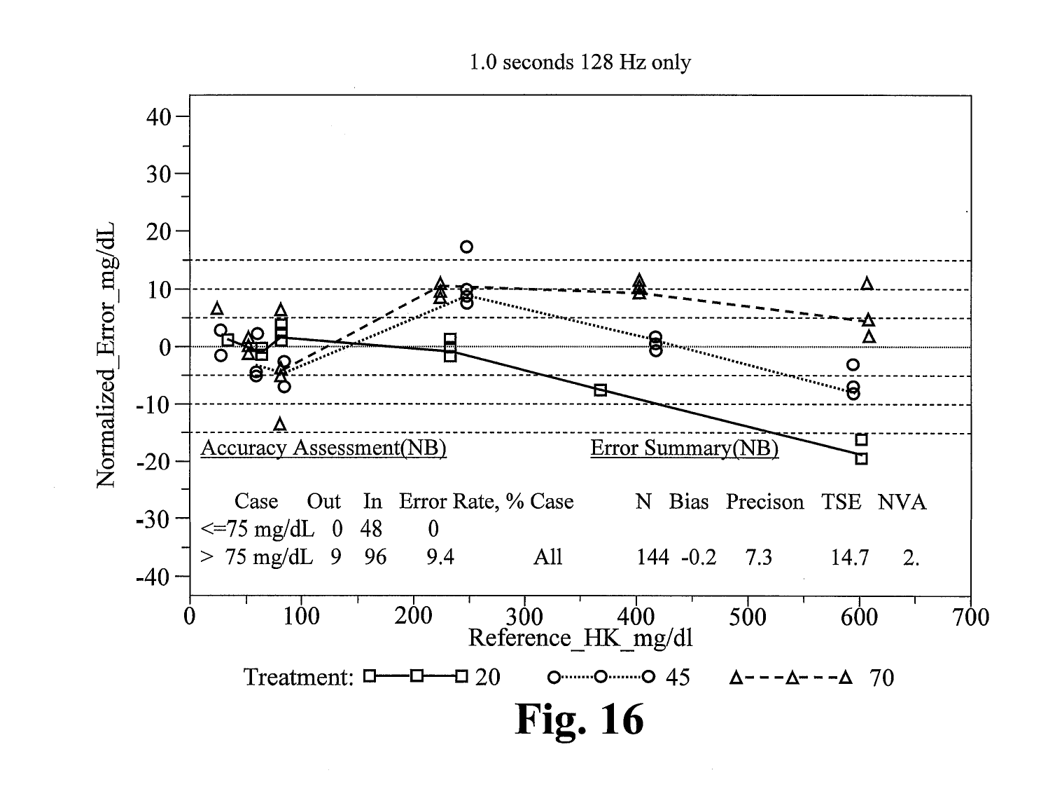

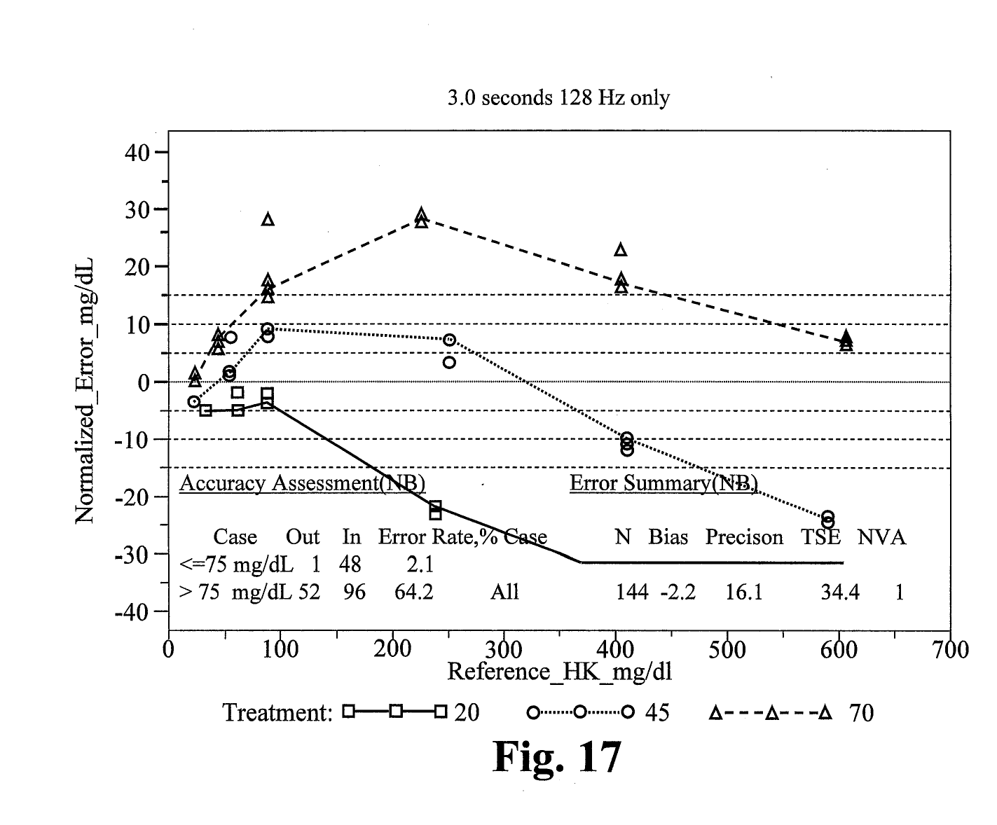

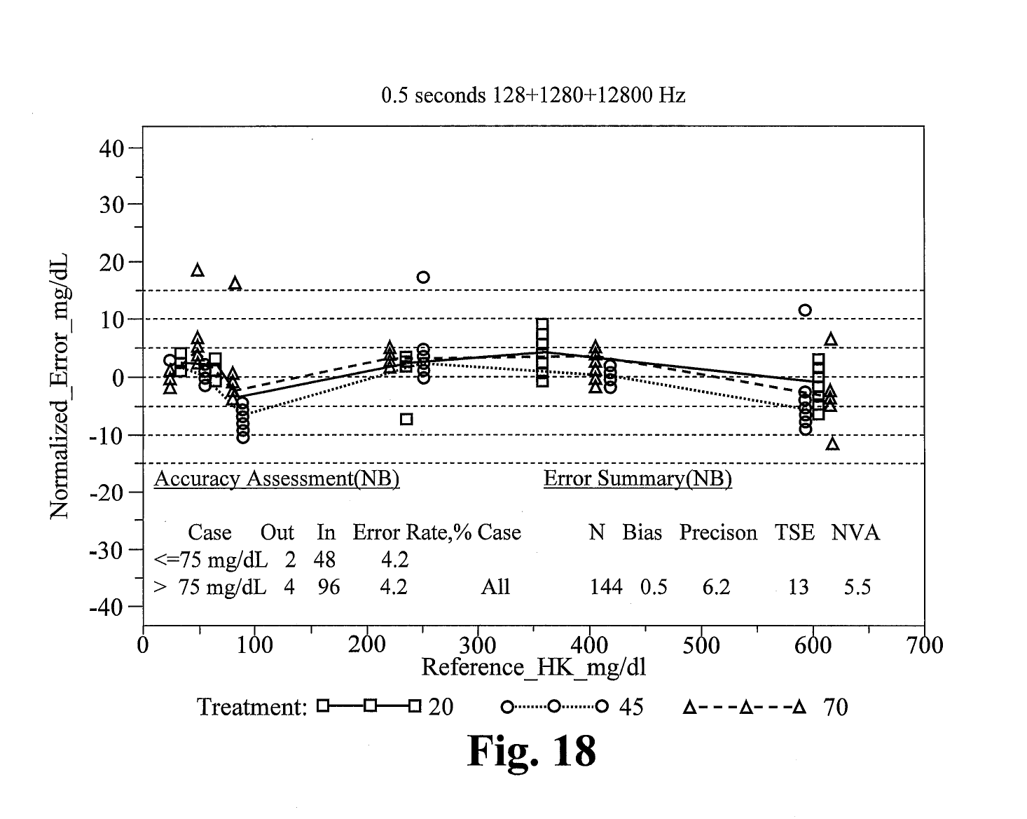

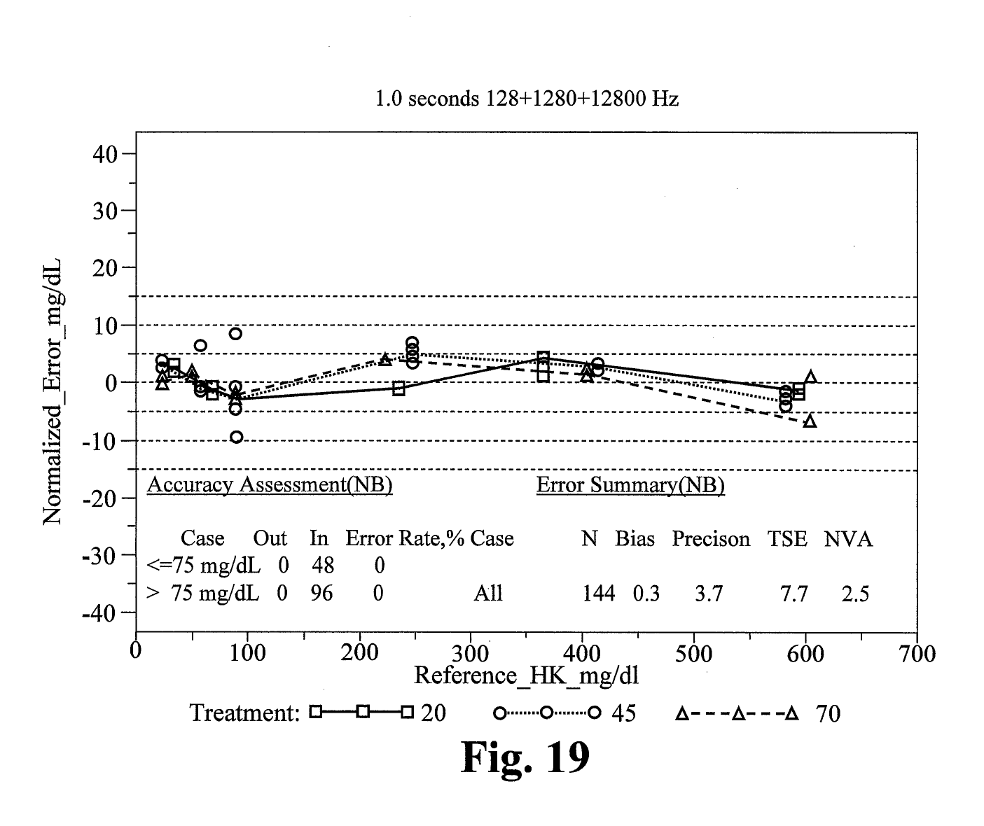

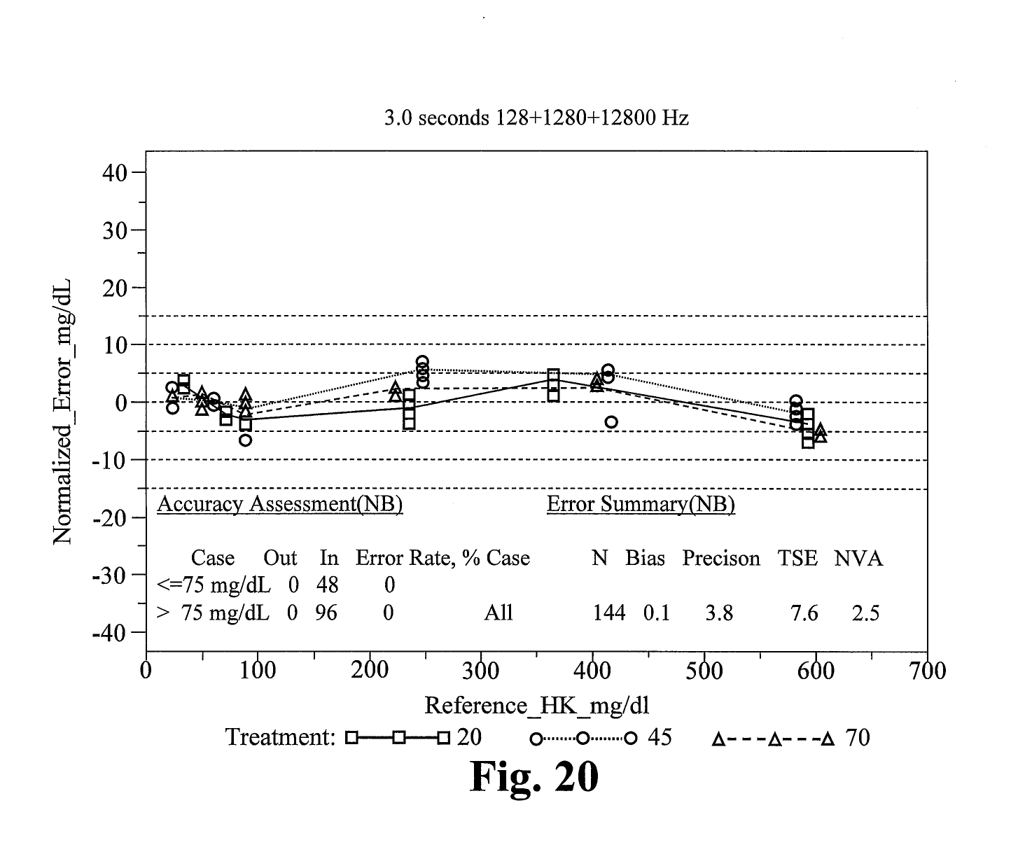

Normalized error is plotted versus the reference glucose values using only the 128 Hz data at 0.5 second, 1.0 second and 3.0 seconds from dose detection, in FIGS. 15-17 respectively. Normalized error is plotted versus the reference glucose values using the combined 128 Hz, 1280 Hz and 12800 Hz data at 0.5 second, 1.0 second and 3.0 seconds in FIGS. 18-20 respectively. The total system error for each of the six data sets is summarized in Table 1 below.

TABLE 1
Total System Error

| Time | 128 Hz Only | 128 Hz + 1280 Hz + 12800 Hz |
|---|---|---|
| 0.5 second | 17% | 13% |
| 1.0 second | 14.7% | 7.7% |
| 3.0 seconds | 34.4% | 7.6% |

The above experiment clearly shows the feasibility of a continuous mixed frequency waveform for use as an excitation signal for the simultaneous measurement of analyte and correction for interferents in a very short time. Including time for processing the data and displaying a result by a handheld meter or other suitable programmable potentiostat, the total measurement time for the measurements compiled in Table 1 can be about 4 seconds, about 2 seconds, or as low as about 1 second.

Persons of ordinary skill in the art of electrochemical sensors, in conjunction with the teachings contained herein and in the methods disclosed in co-pending published U.S. patent applications US-2004-0157339-A1, US-2004-0157337-A1, 2004/0157338-A1, US-2004-0260511-A1, US-2004-0256248-A1 and US-2004-0259180-A1, will be able to utilize the multi-frequency method for enhancing the accuracy of the analyte measurement using sequential frequency application. For example, a signal applying low potential AC excitations at higher frequencies (e.g. 9 mV rms at 1280 Hz and 12800 Hz) followed by a high potential AC excitation at a lower frequency (e.g. 300 mV rms at 128 Hz as disclosed hereinabove) enables a determination of interferent correction followed by a determination of analyte concentration to be adjusted based on the interferent correction.

A further experiment was conducted to investigate systems and methods embodying the present invention when the sample is excited by multiple AC frequencies and also both AC and DC excitations. A covariate study was performed on whole blood samples having four different glucose target concentrations (50, 100, 200 and 600 mg/dL) and three different hematocrit target concentrations (25%, 45% and 65%). AC data was collected using excitation signals of 10 kHz, 2 kHz and 1 kHz at 9 mV rms, and at 128 Hz at 300 mV rms. Then a DC potential of 550 mV was applied. The measurements of the present example utilized both low and high potential AC excitations to the sample.

A two AC model was used to analyze the data as follows:
Glucose=Int+Yi1*Y1+Pi1*P1+Yi2*Y2+Pi2*P2+exp(slope+Ys1*Y1+Ps1*P1+Ys2*Y2+Ps2*P2)*K**Power (Eq. 6)
where 1 is the first AC frequency used, 2 is the second AC frequency used, and K may be either the K value from Equations 4 and 5, or a parameter derived from the 128 Hz/300 mV measurement (see next paragraph). Equation 6 is limited here to two different AC excitations for purposes of simplicity. However, Equation 6 can be expanded to include any number of different AC excitations.

Because this model was designed for values that increase with glucose concentration, it was necessary to derive a parameter from the admittance ratio values used in the examples above. This was done according to the formula:
K3=90−Arctan(admittance ratio) (Equation 7)
The value of K3 was substituted for the K value in Equation 6 in the analysis below using only AC data. AC data was collected for 2.1 seconds, followed by a short open circuit, after which DC signal data was collected for an additional 2.725 seconds.

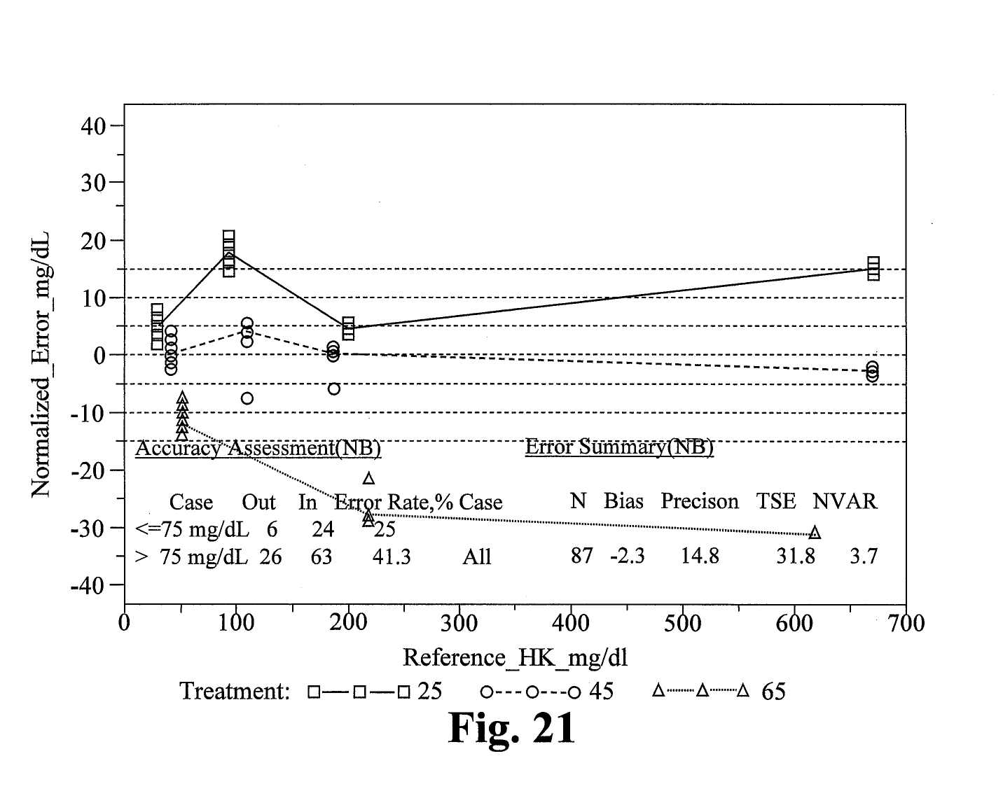

FIG. 21 plots the results of using only the collected DC signal data in the analysis. Normalized error is plotted versus the reference glucose level for each of the measured samples. The error caused by the variable sample hematocrit is quite recognizable, and the results exhibit a total system error (TSE) of 31.8 mg/dL %.

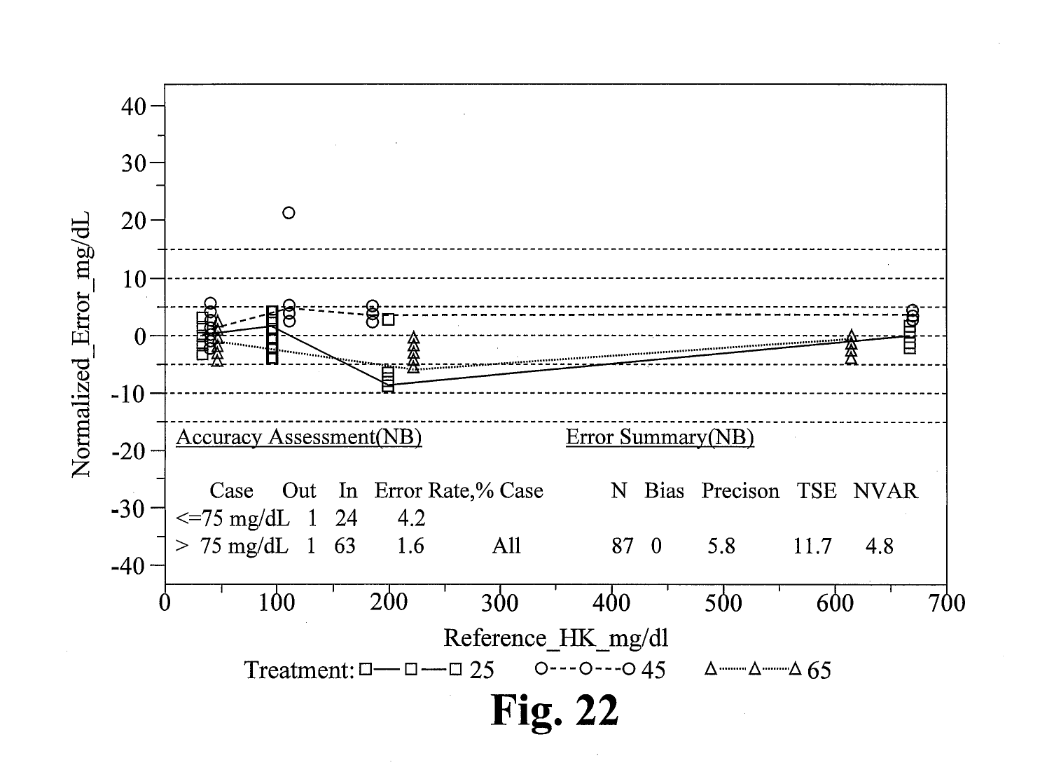

FIG. 22 plots the results of correcting the DC signal data using the AC data at 10 kHz/9 mV and 1 kHz/9 mV using the methodology discussed hereinabove. The total system error was significantly reduced to 11.7 mg/dL % by including the AC data in the analysis.

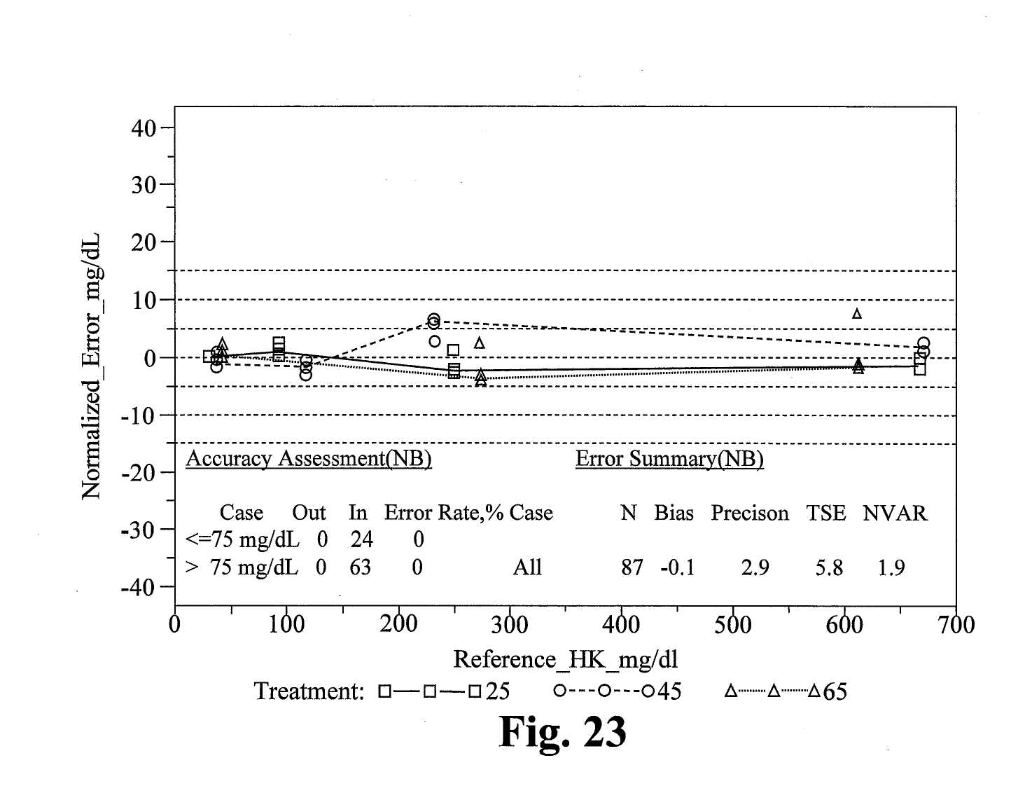

FIG. 23 plots the results of correcting the DC signal data using the AC data at 10 kHz/9 mV and 128 Hz/300 mV using the methodology discussed hereinabove. The total system error was reduced even further to 5.8 mg/dL % by including the AC data in the analysis, illustrating the effectiveness of the 128 Hz/300 mV data for correction of the DC signal response.

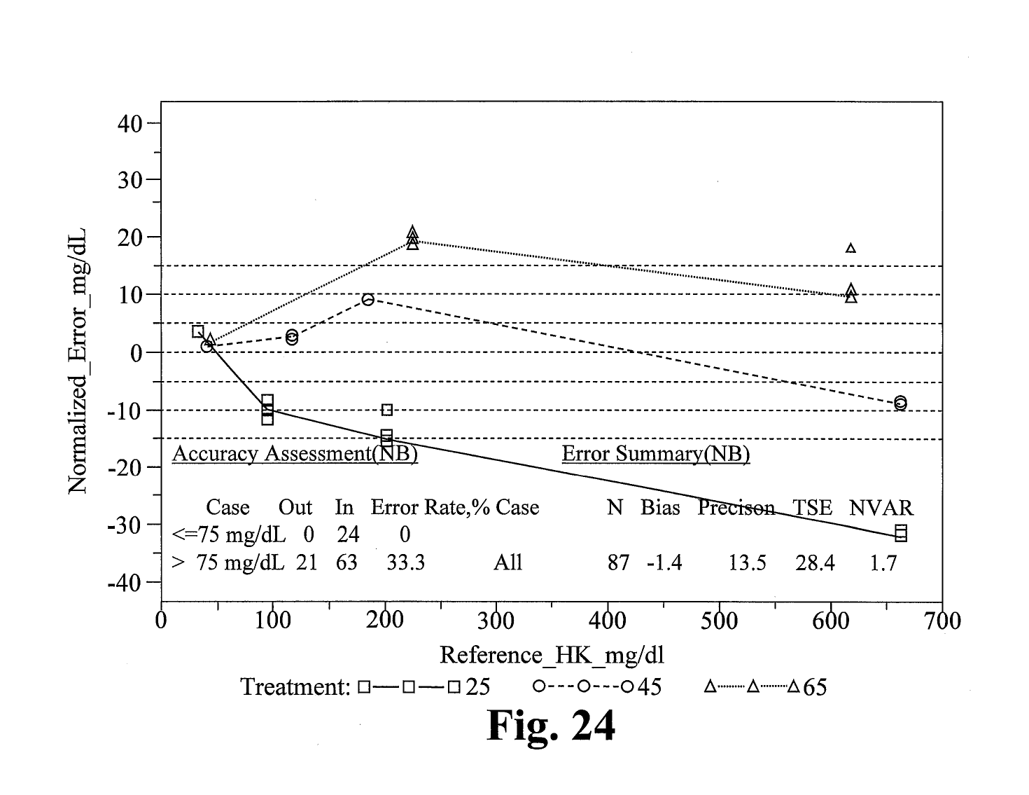

FIG. 24 plots the results of using the K3 parameter (Equation 7) derived from the 128 Hz/300 mV data using the methodology discussed hereinabove. A hematocrit effect can be recognized, especially at high glucose levels. The total system error was 28.4 mg/dL %, which is performance similar to the pure DC signal measurement of FIG. 21.

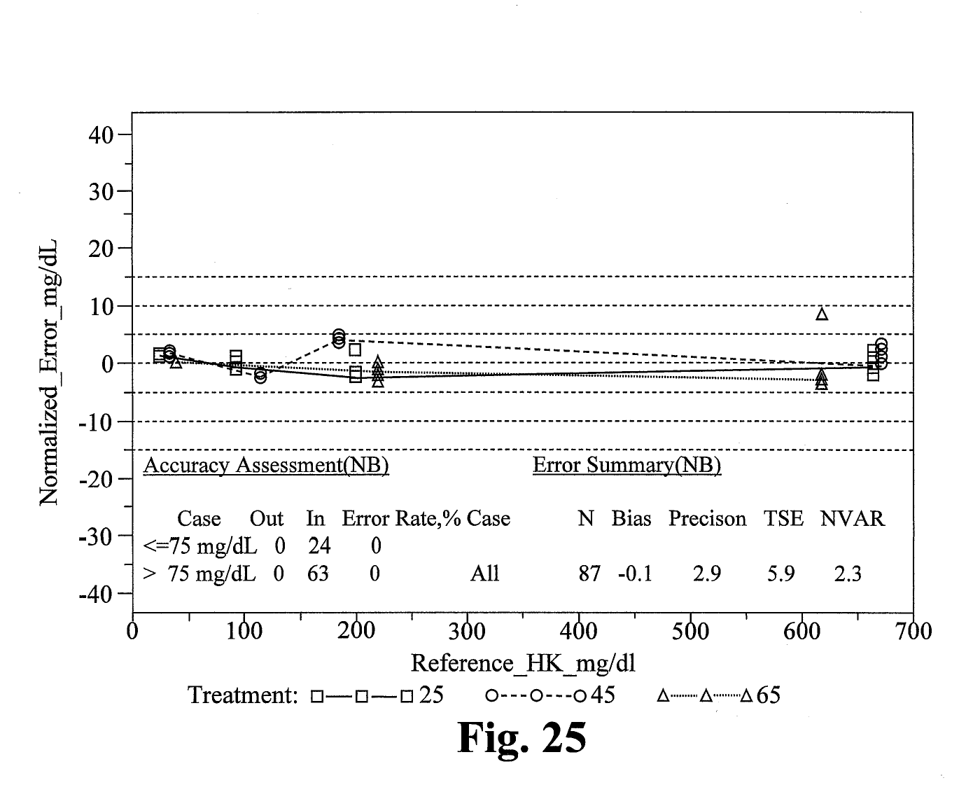

FIG. 25 plots the results of correcting the K3 data using the AC data at 10 kHz/9 mV and 1 kHz/9 mV using the methodology discussed hereinabove. Note that this is a pure AC test, with only the data obtained between 0 and 2.1 seconds being used in the calculation. The total system error was reduced even further to 5.9 mg/dL %.

As shown by the above example, the systems and methods of the present invention are useful for pure AC measurements, for combination with other AC measurement methods, or for combination with other AC and DC measurements to predict analyte concentrations rapidly, accurately and robustly.

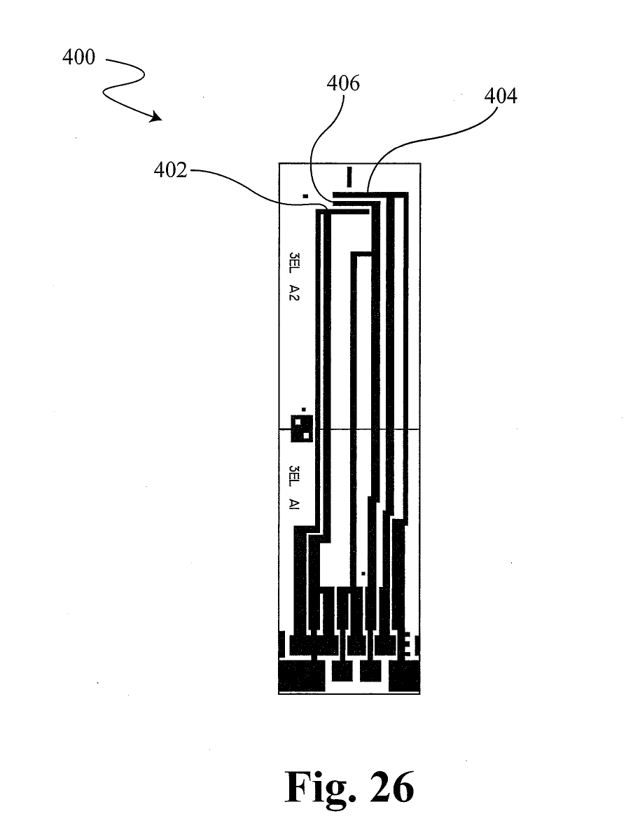

As illustrated in FIG. 26, an alternative sensor design 400 was also investigated using the method of the invention. This design had a single working electrode 402 and two counter electrodes 404 and 406 of the same dimension which could be contacted individually (although a common contact would also suffice), providing a symmetric cell for the AC measurement. These sensors 400 were tested with the method of the invention with blood samples ranging from 0 to 520 mg/dL and hematocrit ranging from 22% to 65%. With the application of DC+low-potential AC at 10 kHz and 2 kHz and calculation of the glucose values using prior art techniques, the Total System Error of the experiment was 14.9%. Utilizing the method of the present invention and application of AC at 128 Hz, 300 mV+low-potential AC at 10 kHz and 2 kHz, the Total System Error was 11%. Utilizing the method of the present invention and application of DC+128 Hz 300 mV AC+low-potential AC 10 kHz, the Total System Error for the experiment was 7.8%. Thus this electrode structure 400 was also clearly effective for carrying out the method of the invention.

In any sensor design in which analyte concentration is determined using purely an AC method as described in this disclosure, and particularly in a design having a symmetric cell 400 as described above, there is no electrode which can be identified as a working electrode as opposed to a counter electrode, as those terms are commonly understood to a person of ordinary skill in the art of electrochemical biosensors. That is, in a system in which a DC signal is used, when the potential is applied, one of the electrodes becomes the anode and the other the cathode. In an electrooxidation sensor, the analyte is oxidized on the anode, and the cathode is the counter electrode. In an electroreduction sensor, the analyte is reduced on the cathode and the anode is the counter electrode. In contrast, for an AC signal devoid of a DC offset, the relative potential between the electrodes changes polarity with the periodicity of the applied potential. Thus the electrode which at one point in the cycle is the anode is at another point in the cycle the cathode. At the same time, the current response driven by that applied potential leads the potential due to the capacitance of the electrochemical cell. See FIGS. 1 and 2. Therefore the electrode which is momentarily the anode can draw a significant cathodic current, and the electrode which is momentarily the cathode can draw a significant anodic current. In addition, in the absence of a DC bias potential, there is no net oxidation or reduction of mediator (or analyte) at either electrode during the measurement. Thus, the measurement can be made continuously over a significant time period without significantly altering the composition of the sample. Repeated measurements can be used to improve the signal-to-noise ratio of the measurement, to monitor the progress of an enzymatic reaction, or to allow the cell to reach a steady state prior to making a final analyte determination. As a result, in sensors which apply the AC-only methods of the present invention, the electrodes are interchangeable, and the sensors do not possess a working electrode and a counter electrode.

While the invention has been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected.

What is claimed is:

1. A method for determining a concentration of a medically significant component of a biological fluid in contact with a reagent compound, comprising the steps of:
a) applying a first signal having an AC component to the biological fluid, wherein the AC component has a magnitude sufficient to generate a faradaic current response from the biological fluid;
b) measuring the current response to the AC component;
c) determining a fundamental component of the current response, said fundamental component comprising a frequency at least substantially the same as the frequency of the AC component of the first signal; and
d) determining from the fundamental component an indication of the concentration of the medically significant component.

2. The method of claim 1, wherein the first signal is an AC signal.

3. The method of claim 1, wherein the current response is at least partially caused by electrochemical processes within the biological fluid

4. The method of claim 1, wherein step (d) comprises determining said indication from a magnitude and phase angle of the fundamental component.

5. The method of claim 1, wherein step (d) comprises determining said indication only from a phase angle of the fundamental component.

6. The method of claim 1, wherein the current response comprises Admittance values.

7. The method of claim 5, wherein step (d) comprises calculating a tangent of the phase angle of the fundamental component.

8. The method of claim 5, wherein the phase angle is calculated relative to a non-zero origin.

9. The method of claim 1, wherein the current response is non-linear, and wherein step (c) comprises calculating a first Fourier component of the current response.

10. The method of claim 9, wherein step (c) comprises calculating a first Fourier component of the current response using a transform selected from the group consisting of a Fast Fourier Transform and a Discrete Fourier Transform.

11. The method of claim 1, wherein the biological fluid is blood.

12. The method of claim 11, wherein the medically significant component is glucose.

13. The method of claim 1, wherein the first signal is sinusoidal.

14. The method of claim 1, wherein the magnitude of the first signal is between about 200 and 550 mV rms.

15. The method of claim 1, wherein the first signal has a frequency of between about 10 and 1000 Hz.

16. The method of claim 1, wherein the first signal has a magnitude of about 300 mV rms and a frequency of about 128 Hz.

17. The method of claim 1, wherein the first signal has a magnitude of about 40 mV rms and a frequency of about 200 Hz.

18. The method of claim 1, wherein the concentration of the medically significant component is determined only from the fundamental component.

19. The method of claim 1, further comprising the step of:
e) before said step (a), detecting that the biological fluid is in contact with the reagent compound, wherein said step (d) occurs within about 4 seconds of said detecting.

20. The method of claim 19, wherein said step (d) occurs within about 2 seconds of said detecting.

21. The method of claim 20, wherein said step (d) occurs within about 1 second of said detecting.

22. The method of claim 1, wherein the first signal further comprises a second AC component having a magnitude insufficient for generating a faradaic current response from the biological fluid, and further comprising the steps of:
e) measuring the current response to the second AC component;
f) determining an interferent correction from the current response to the second AC component; and
g) adjusting the indication of the concentration from the fundamental component using the interferent correction.

23. The method of claim 22, further comprising the step of:
h) before said step (a), detecting that the biological fluid is in contact with the reagent compound, wherein said step (d) and said step (g) occurs within about 4 seconds of said detecting.

24. The method of claim 23, wherein said step (d) and said step (g) occurs within about 2 seconds of said detecting.

25. The method of claim 24, wherein said step (d) and said step (g) occurs within about 1 second of said detecting.

26. The method of claim 22, wherein the first signal further comprises a DC component, and the method further comprising the steps of:
h) measuring the current response to the DC component;
i) determining from the current response to the DC component an indication of the concentration of the medically significant component; and
j) correcting the indication from the DC component using the indication from the fundamental component of the AC component, the corrected indication from the DC component being adjusted using the interferent correction.

27. The method of claim 1, wherein the first signal further comprises a DC component, and the method further comprising the steps of:
e) measuring the current response to the DC component;
f) determining from the current response to the DC component an indication of the concentration of the medically significant component; and
g) correcting the indication from the DC component using the indication from the fundamental component of the AC component.

28. The method of claim 1, wherein said first signal comprises an AC signal having a single frequency.

29. The method of claim 1, wherein said first signal comprises an AC signal and a DC signal.

30. The method of claim 1, wherein said first signal comprises an AC signal having multiple frequencies.

31. A method for determining a concentration of a medically significant component of a biological fluid in contact with a reagent compound, comprising the steps of:
a) applying a first AC signal to the biological fluid, wherein the first AC signal has a magnitude sufficient to generate a faradaic current response from the biological fluid;
b) measuring the current response to the first AC signal;
c) determining a fundamental component of the current response, said fundamental component comprising a frequency at least substantially the same as the frequency of the first signal; and
d) determining from the fundamental component an indication of the concentration of the medically significant component.

32. The method of claim 31, wherein the current response is at least partially caused by electrochemical processes within the biological fluid.

33. The method of claim 31, wherein step (d) comprises determining said indication from a magnitude and phase angle of the fundamental component.

34. The method of claim 31, wherein step (d) comprises determining said indication only from a phase angle of the fundamental component.

35. The method of claim 31, wherein the current response comprises Admittance values.

36. The method of claim 34, wherein step (d) comprises calculating a tangent of the phase angle of the fundamental component.

37. The method of claim 34, wherein the phase angle is calculated relative to a non-zero origin.

38. The method of claim 31, wherein the current response is non-linear, and wherein step (c) comprises calculating a first Fourier component of the current response.

39. The method of claim 38, wherein step (c) comprises calculating a first Fourier component of the current response using a transform selected from the group consisting of a Fast Fourier Transform and a Discrete Fourier Transform.

40. The method of claim 31, wherein the biological fluid is blood.

41. The method of claim 40, wherein the medically significant component is glucose.

42. The method of claim 31, wherein the first AC signal is sinusoidal.

43. The method of claim 31, wherein the magnitude of the first signal is between about 200 and 550 mV rms.

44. The method of claim 31, wherein the first signal has a frequency of between about 10 and 1000 Hz.

45. The method of claim 31, wherein the first signal has a magnitude of about 300 mV rms and a frequency of about 128 Hz.

46. The method of claim 31, wherein the first signal has a magnitude of about 40 mV rms and a frequency of about 200 Hz.

47. The method of claim 31, wherein the concentration of the medically significant component is determined only from the fundamental component.

48. The method of claim 31, further comprising the step of:
e) before said step (a), detecting that the biological fluid is in contact with the reagent compound, wherein said step (d) occurs within about 4 seconds of said detecting.

49. The method of claim 48, wherein said step (d) occurs within about 2 seconds of said detecting.

50. The method of claim 49, wherein said step (d) occurs within about 1 second of said detecting.

51. The method of claim 31, further comprising the steps of:
e) applying a second AC signal to the biological fluid, wherein the second AC signal has a magnitude insufficient for generating a faradaic current response from the biological fluid;
f) measuring the current response to the second AC signal;
g) determining an interferent correction from a phase angle of the current response to the second AC signal; and
h) adjusting the indication of the concentration from the fundamental component using the interferent correction.

52. The method of claim 51, further comprising the step of:
i) before said step (a), detecting that the biological fluid is in contact with the reagent compound, wherein said step (d) and said step (h) occurs within about 4 seconds of said detecting.

53. The method of claim 52, wherein said step (d) and said step (h) occurs within about 2 seconds of said detecting.

54. The method of claim 53, wherein said step (d) and said step (h) occurs within about 1 second of said detecting.

55. The method of claim 51, further comprising the steps of:
i) applying a DC signal to the biological fluid;
j) measuring the current response to the DC signal;
k) determining from the current response to the DC signal an indication of the concentration of the medically significant component; and
l) correcting the indication from the DC signal using the indication from the fundamental component of the first AC signal, the corrected indication from the DC component being adjusted using the interferent correction.

56. The method of claim 31, further comprising the steps of:
e) applying a DC signal to the biological fluid;
f) measuring the current response to the DC signal;
g) determining from the current response to the DC signal an indication of the concentration of the medically significant component; and
h) correcting the indication from the DC signal using the indication from the fundamental component of the AC signal.

57. The method of claim 31, wherein said first AC signal comprises an AC signal having a single frequency.

58. The method of claim 31, wherein said first AC signal comprises an AC signal having multiple frequencies.

59. A method for determining a glucose concentration of a blood sample in contact with a reagent compound, comprising the steps of:
a) applying a first signal having an AC component to the blood sample, wherein the AC component has a magnitude sufficient to generate a faradaic current response from the blood sample;
b) measuring the current response to the AC component;
c) determining a fundamental component of the response, said fundamental component comprising a frequency at least substantially the same as the frequency of the AC component of the first signal; and
d) determining from the fundamental component an indication of the glucose concentration.

60. The method of claim 59, wherein the first signal is an AC signal.

61. The method of claim 59, wherein the current response is at least partially caused by electrochemical processes within the blood sample.

62. The method of claim 59, wherein step (d) comprises determining said indication from a magnitude and phase angle of the fundamental component.

63. The method of claim 59, wherein step (d) comprises determining said indication only from a phase angle of the fundamental component.

64. The method of claim 59, wherein the current response comprises Admittance values.

65. The method of claim 62, wherein step (d) comprises calculating a tangent of the phase angle of the fundamental component.

66. The method of claim 62, wherein the phase angle is calculated relative to a non-zero origin.

67. The method of claim 59, wherein the current response is non-linear, and wherein step (c) comprises calculating a first Fourier component of the current response.

68. The method of claim 67, wherein step (c) comprises calculating a first Fourier component of the current response using a transform selected from the group consisting of a Fast Fourier Transform and a Discrete Fourier Transform.

69. The method of claim 59, wherein the first signal is sinusoidal.

70. The method of claim 59, wherein the magnitude of the first signal is between about 200 and 500 mV rms.

71. The method of claim 59, wherein the first signal has a frequency of between about 100 and 1000 Hz.

72. The method of claim 59, wherein the first signal has a magnitude of about 300 mV rms and a frequency of about 128 Hz.

73. The method of claim 59, wherein the first signal has a magnitude of about 40 mV rms and a frequency of about 200 Hz.

74. The method of claim 59, wherein the glucose concentration is determined only from the fundamental component.

75. The method of claim 59, further comprising the step of:
e) before said applying the first signal, detecting that the blood is in contact with the reagent compound, wherein said step (d) occurs within about 4 seconds of said detecting.

76. The method of claim 75, wherein said step (d) occurs within about 2 seconds of said detecting.

77. The method of claim 76, wherein said step (d) occurs within about 1 second of said detecting.

78. The method of claim 59, wherein the first signal further comprises a second AC component having a magnitude insufficient for generating a faradaic current response from the blood, and the method further comprising the steps of:
e) measuring the current response to the second AC component;
f) determining an interferent correction from a phase angle of the current response to the second AC component; and
g) adjusting the indication of the concentration from the fundamental component using the interferent correction.

79. The method of claim 78, further comprising the step of:
h) before said step (a), detecting that the blood is in contact with the reagent compound, wherein said step (d) and said step (g) occurs within about 4 seconds of said detecting.

80. The method of claim 79, wherein said step (d) and said step (g) occurs within about 2 seconds of said detecting.

81. The method of claim 80, wherein said step (d) and said step (g) occurs within about 1 second of said detecting.

82. The method of claim 78, wherein the first signal further comprises a DC component, and the method further comprising the steps of:
h) measuring the current response to the DC component;
i) determining from the current response to the DC component an indication of the concentration of glucose; and
j) correcting the indication from the DC component using the indication from the fundamental component of the AC component, the corrected indication from the DC component being adjusted using the interferent correction.

83. The method of claim 59, wherein the first signal further comprises a DC component, and the method further comprising the steps of:
e) measuring the current response to the DC component;
f) determining from the current response to the DC component an indication of the concentration of glucose; and
g) correcting the indication from the DC component using the indication from the fundamental component of the AC component.

84. The method of claim 59, wherein said first signal comprises an AC signal having a single frequency.

85. The method of claim 59, wherein said first signal comprises an AC signal having multiple frequencies.

86. The method of claim 59, wherein said first signal comprises and AC signal and a DC signal.

87. A system for determining a concentration of a medically significant component of a biological fluid, the system comprising:
a biosensor comprising at least two electrically isolated electrodes and a reagent compound proximal to or in contact with at least one of the electrodes;
a measurement device in electrical communication with the electrodes of the biosensor, the device being configured and arranged to conduct a measurement sequence and data evaluation when the biological fluid is brought into contact with the at least two electrodes and the reagent compound to bring the electrodes into electrical communication with each other, the fluid and the reagent compound;
said measurement sequence comprising:
application of a first signal having an AC component to the biological fluid using the at least two electrodes, wherein the AC component has a magnitude sufficient to generate a faradaic current response from the biological fluid;
measurement of the current response to the AC component;
determination of a fundamental component of the current response, said fundamental component comprising a frequency at least substantially the same as the frequency of the AC component of the first signal; and
determination from the fundamental component of an indication of the concentration of the medically significant component.

88. The system of claim 87, wherein the determination of an indication of the concentration comprises determination of said indication from a magnitude and phase angle of the fundamental component.

89. The system of claim 87, wherein the current response comprises Admittance values.

90. The system of claim 87, wherein the determination of an indication of the concentration comprises a calculation of the phase angle of the fundamental component, the phase angle being calculated relative to a non-zero origin.

91. The system of claim 87, wherein the current response is non-linear, and wherein the determination of a fundamental component of the current response comprises calculation of a first Fourier component of the current response.

92. The system of claim 87, wherein the biological fluid is blood.

93. The system of claim 92, wherein the medically significant component is glucose.

94. The system of claim 87, wherein the first signal is sinusoidal.

95. The system of claim 87, wherein the magnitude of the first signal is between about 200 and 550 mV rms.

96. The system of claim 87, wherein the first signal has a frequency of between about 10 and 1000 Hz.

97. The system of claim 87, wherein the first signal has a magnitude of about 300 mV rms and a frequency of about 128 Hz.

98. The system of claim 87, wherein the first signal has a magnitude of about 40 mV rms and a frequency of about 200 Hz.

99. The system of claim 87, wherein the measurement sequence further comprises detection of the biological fluid being in contact with the reagent compound before the application of the first signal, wherein the determination of the indication of concentration occurs within about 4 seconds of the detection.

100. The system of claim 99, wherein the determination of the indication of concentration occurs within about 2 seconds of the detection.

101. The system of claim 100, wherein the determination of the indication of concentration occurs within about 1 second of the detection.

102. The system of claim 87, wherein the first signal further comprises a second AC component having a magnitude insufficient for generating a faradaic current response from the biological fluid, and the measurement sequence further comprises measurement of the current response to the second AC component, determination of an interferent correction from a phase angle of the current response to the second AC component, and an adjustment to the indication of the concentration from the fundamental component using the interferent correction.

103. The system of claim 102, wherein the measurement sequence further comprises detection of the biological fluid being in contact with the reagent compound before the application of the first signal, wherein the determination of the indication of concentration and the adjustment to the indication using the interferent correction occurs within about 4 seconds of the detection.

104. The system of claim 103, wherein the determination of the indication of concentration and the adjustment to the indication using the interferent correction occurs within about 2 seconds of the detection.

105. The system of claim 104, wherein the determination of the indication of concentration and the adjustment to the indication using the interferent correction occurs within about 1 second of the detection.

106. The system of claim 102, wherein the first signal further comprises a DC component, and the measurement sequence further comprises a measurement of the current response to the DC component, a determination from the current response to the DC component of an indication of the concentration of the medically significant component, and a correction to the indication from the DC component using the indication from the fundamental component of the AC component, the corrected indication from the DC component being adjusted using the interferent correction.

107. The system of claim 87, wherein the first signal further comprises a DC component, and the measurement sequence further comprises a measurement of the current response to the DC component, determination from the current response to the DC component of an indication of the concentration of the medically significant component, and a correction to the indication from the DC component using the indication from the fundamental component of the AC component.

108. The system of claim 87, wherein said first signal comprises an AC signal having a single frequency.

109. The system of claim 87, wherein said first signal comprises an AC signal and a DC signal.

110. The system of claim 87, wherein said first signal comprises an AC signal having multiple frequencies.

111. The method of claim 27, wherein the AC component and the DC component are applied sequentially.

112. The method of claim 56, wherein the AC signal and the DC signal are applied sequentially.

113. The method of claim 82, wherein the AC component, the second AC component and the DC component are applied sequentially.

114. The method of claim 106, wherein the AC component, the second AC component and the DC component are applied sequentially.
